(19) United States
(12) Patent Application Publication
(10) Pub. No.: US 2014/0377041 A1
(43) Pub. Date: Dec. 25, 2014

(54) Lift And Storage Racking Apparatus For Human Remains

(71) Applicant: Kevin Edwin Humphreys, Columbus, OH (US)

(72) Inventor: Kevin Edwin Humphreys, Columbus, OH (US)

(21) Appl. No.: 14/313,149

(22) Filed: Jun. 24, 2014

Related U.S. Application Data
(60) Provisional application No. 61/839,091, filed on Jun. 25, 2013.

(51) Int. Cl. B65G 1/06; F25D 25/04; F25D 23/10

(52) U.S. Cl. CPC B65G 1/06; F25D 23/10; F25D 25/04
USPC 414/278; 414/807

(57) ABSTRACT

The apparatus is a Lift and Storage Racking Apparatus for Human Remains to store human remains in an efficient manner. The lift component of the apparatus, through other connected components, when operated will either raise or lower human remains vertically, while maintaining the horizontal orientation of the human remains. The storage component of the apparatus accommodates extraordinary variations in the height, width, depth, and weight of human remains. Parallel storage rollers, glides, slides, and/or bearings facilitate efficient loading and unloading, as well as, expansion of the depth of storage for multiple human remains. Additional vertical levels placed within the storage component proportionally increase the capacity of the storage component. The apparatus is suitable for new installation as well as existing spaces for the storage of human remains; including but not limited to temperature controlled environments, such as buildings, structures, rooms, coolers, and/or freezers.

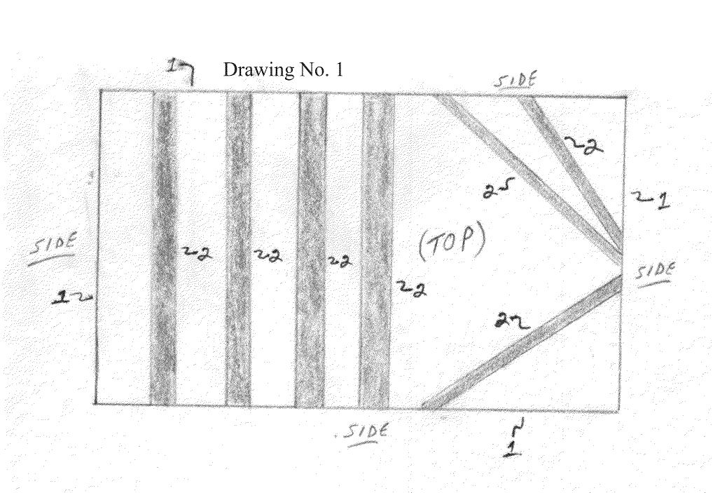

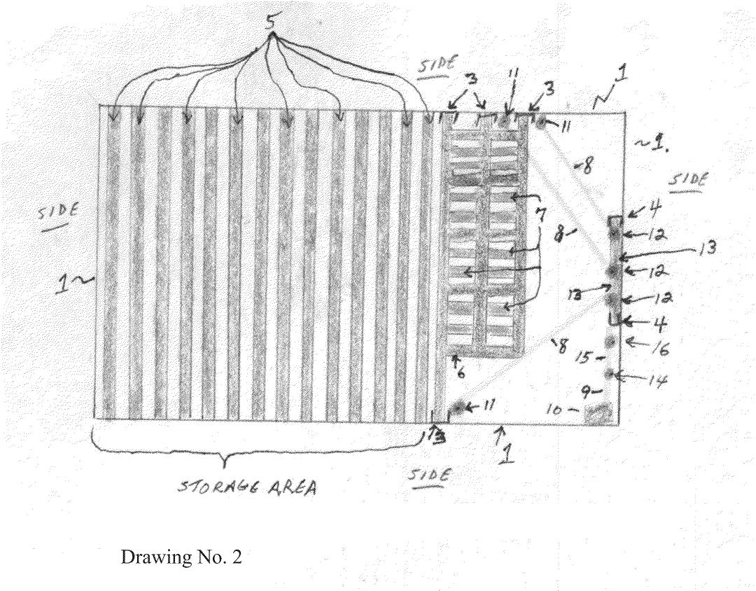

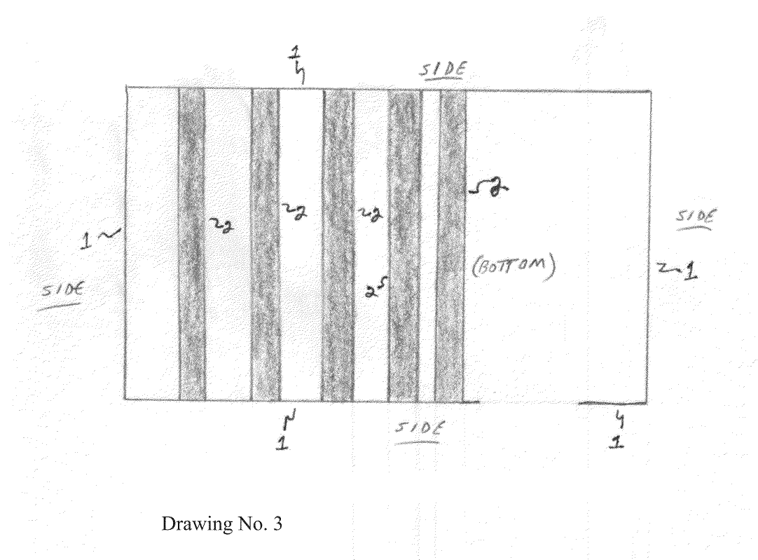

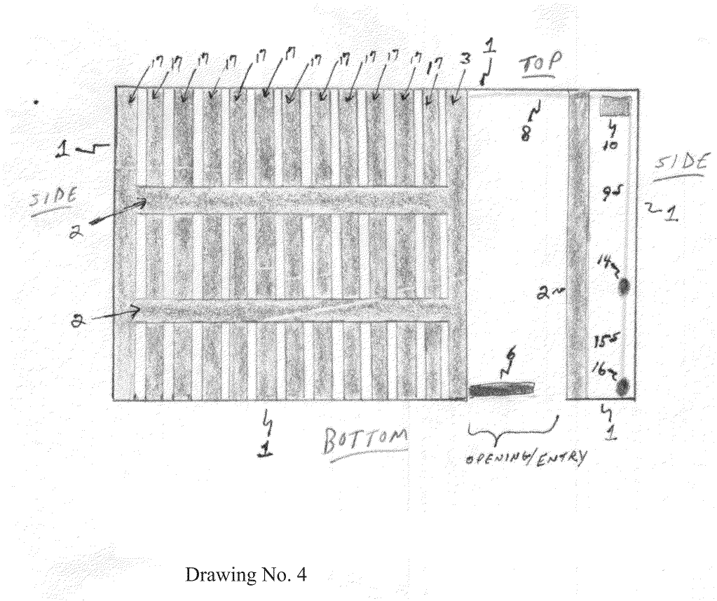

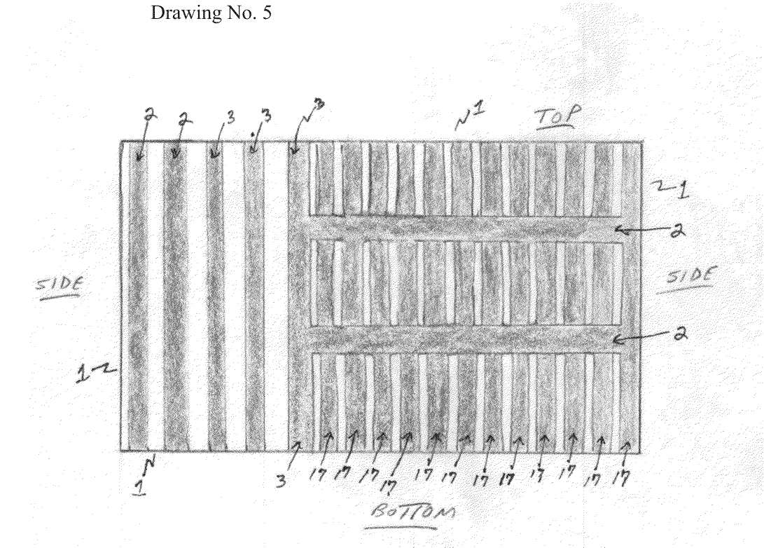

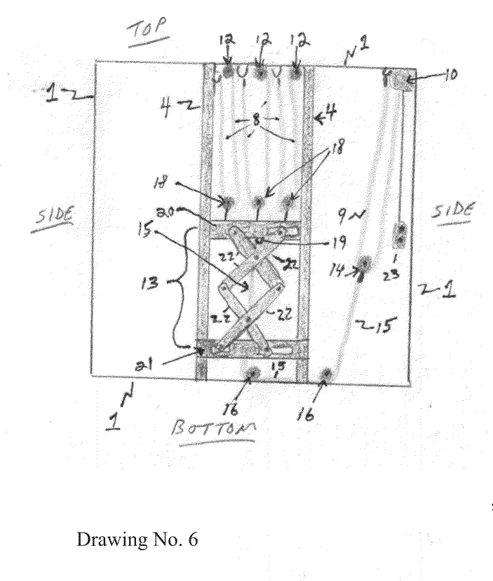

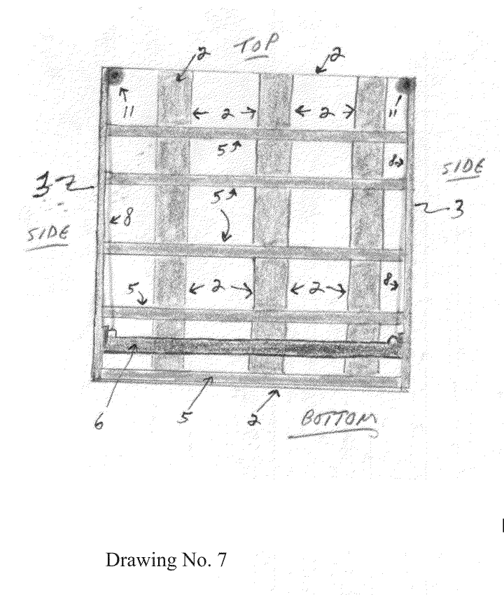

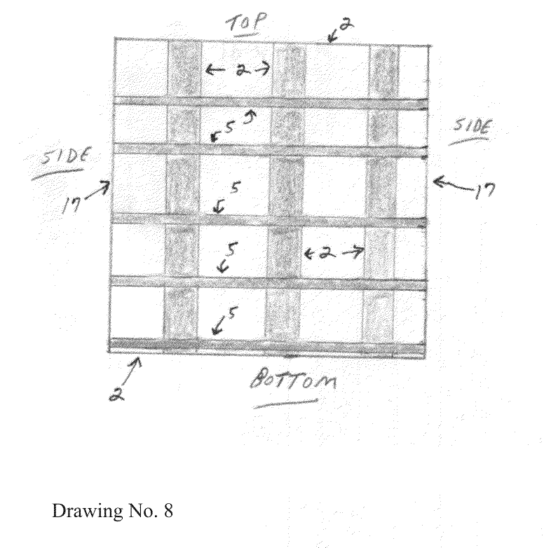

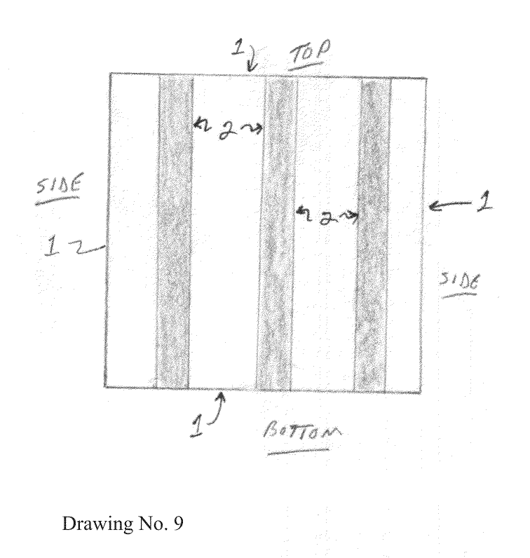

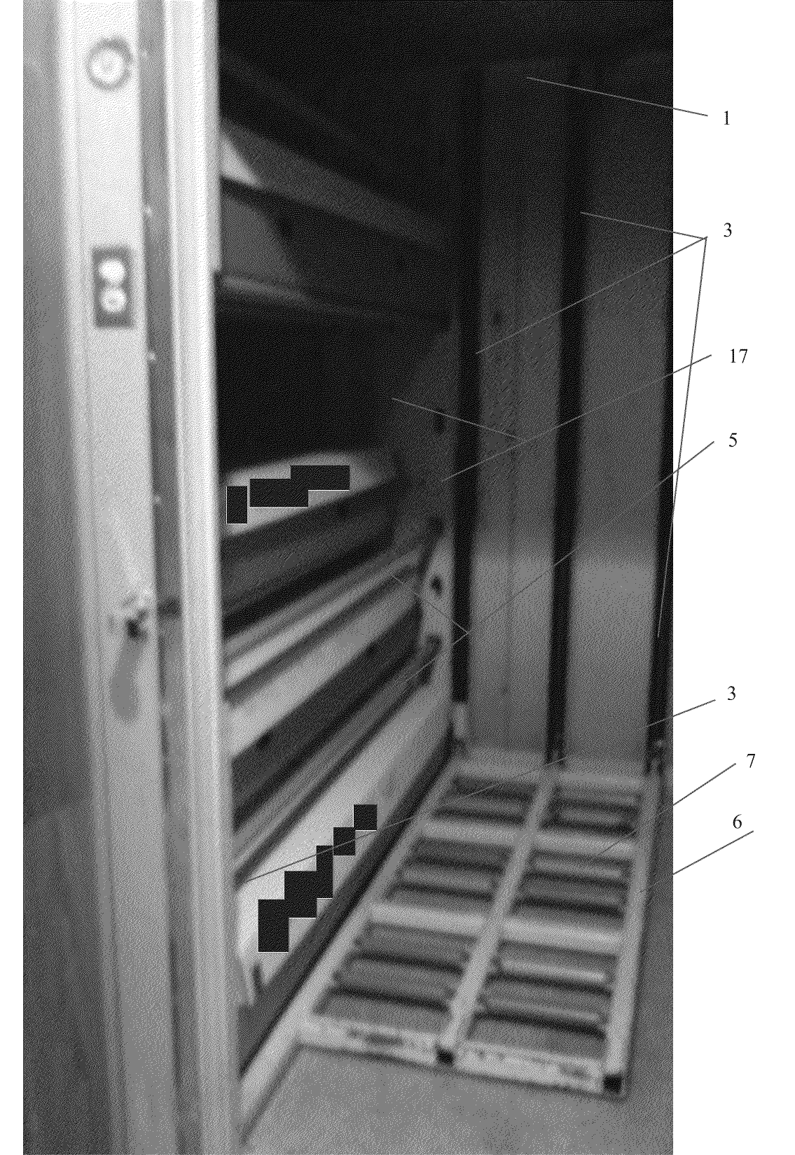

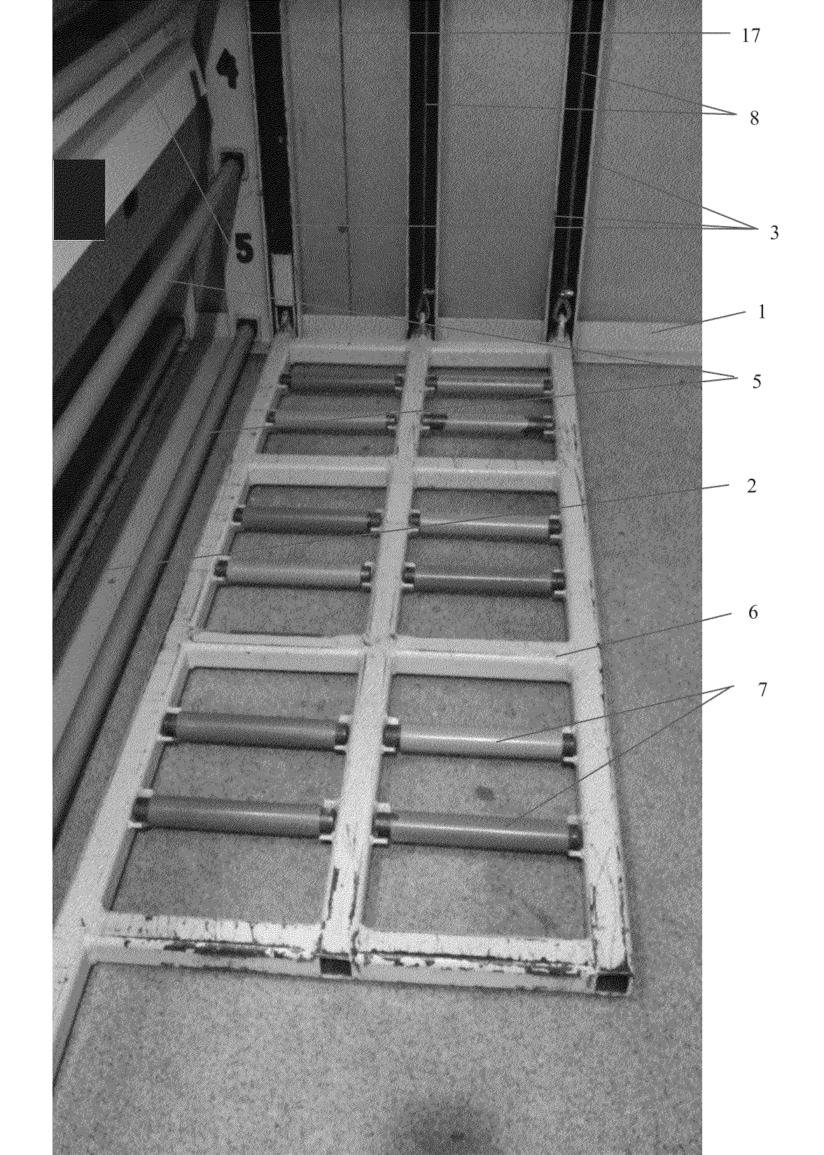

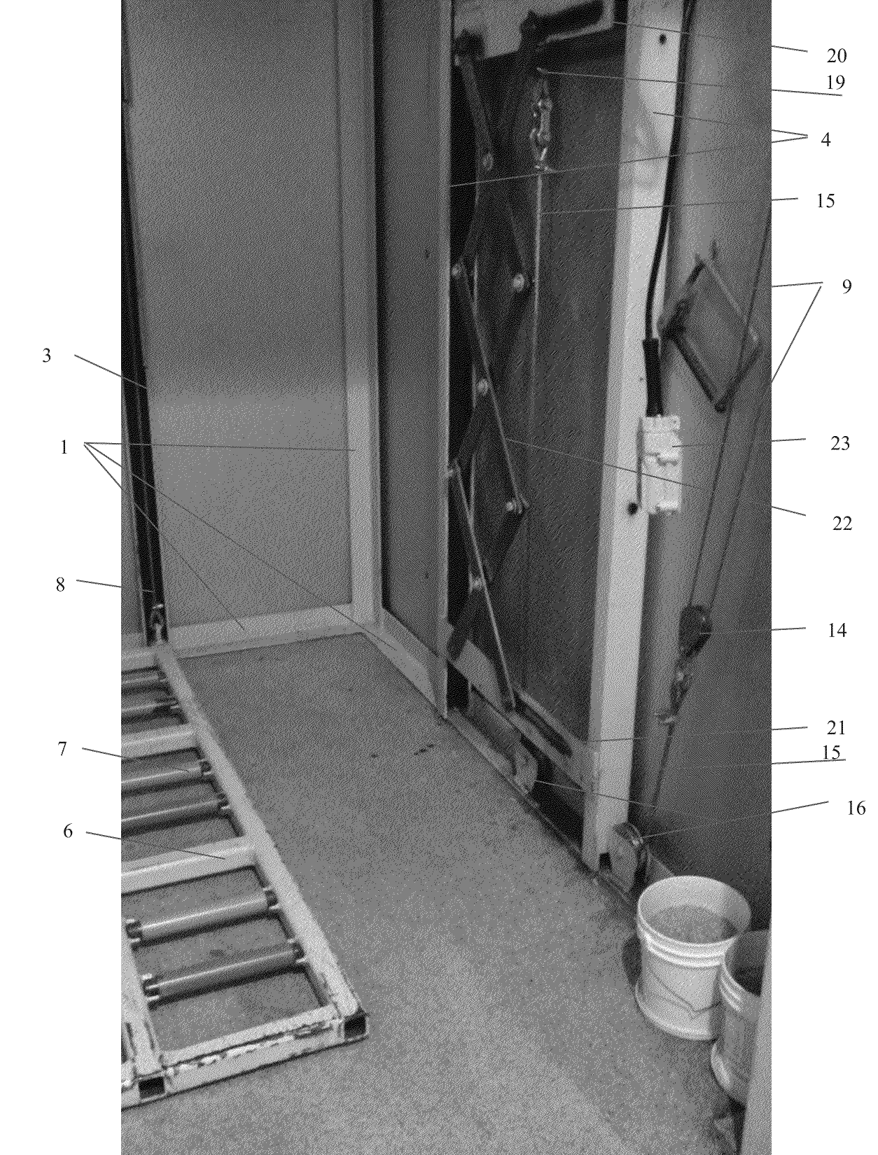

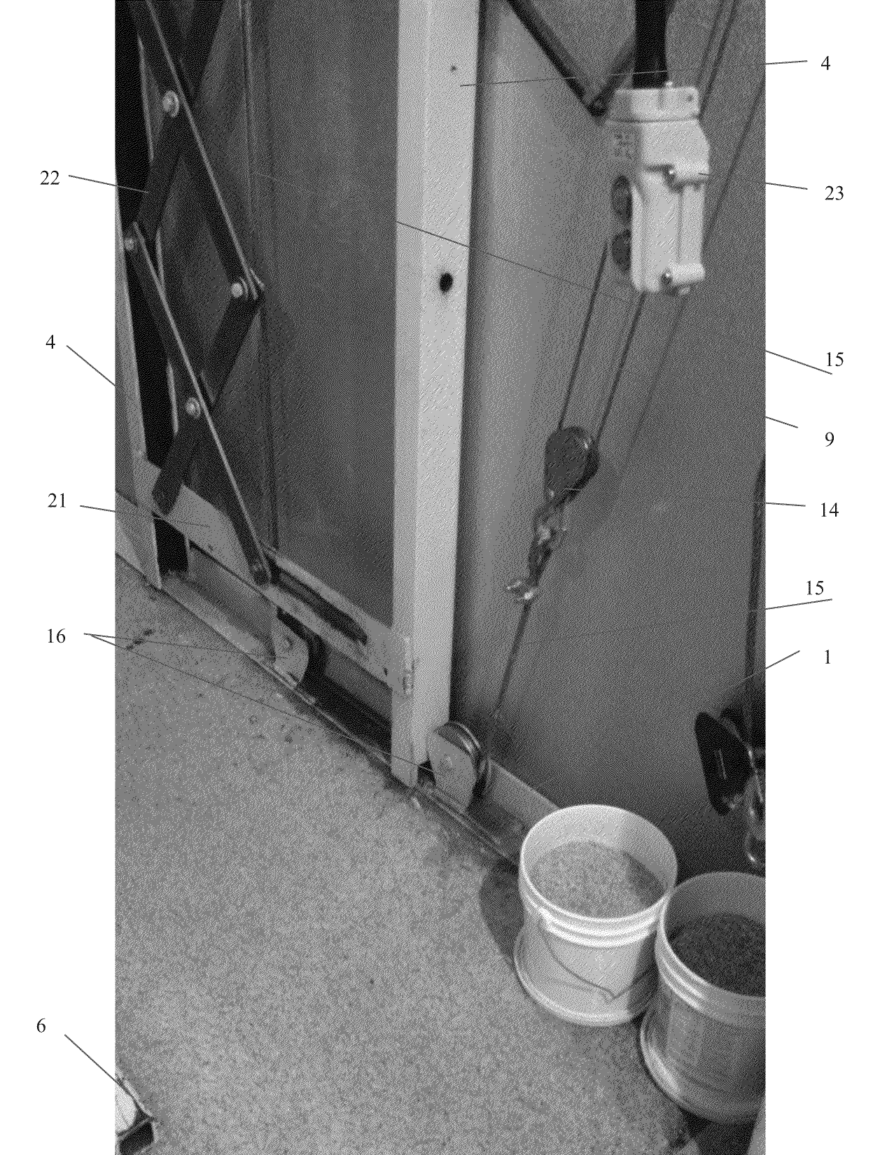

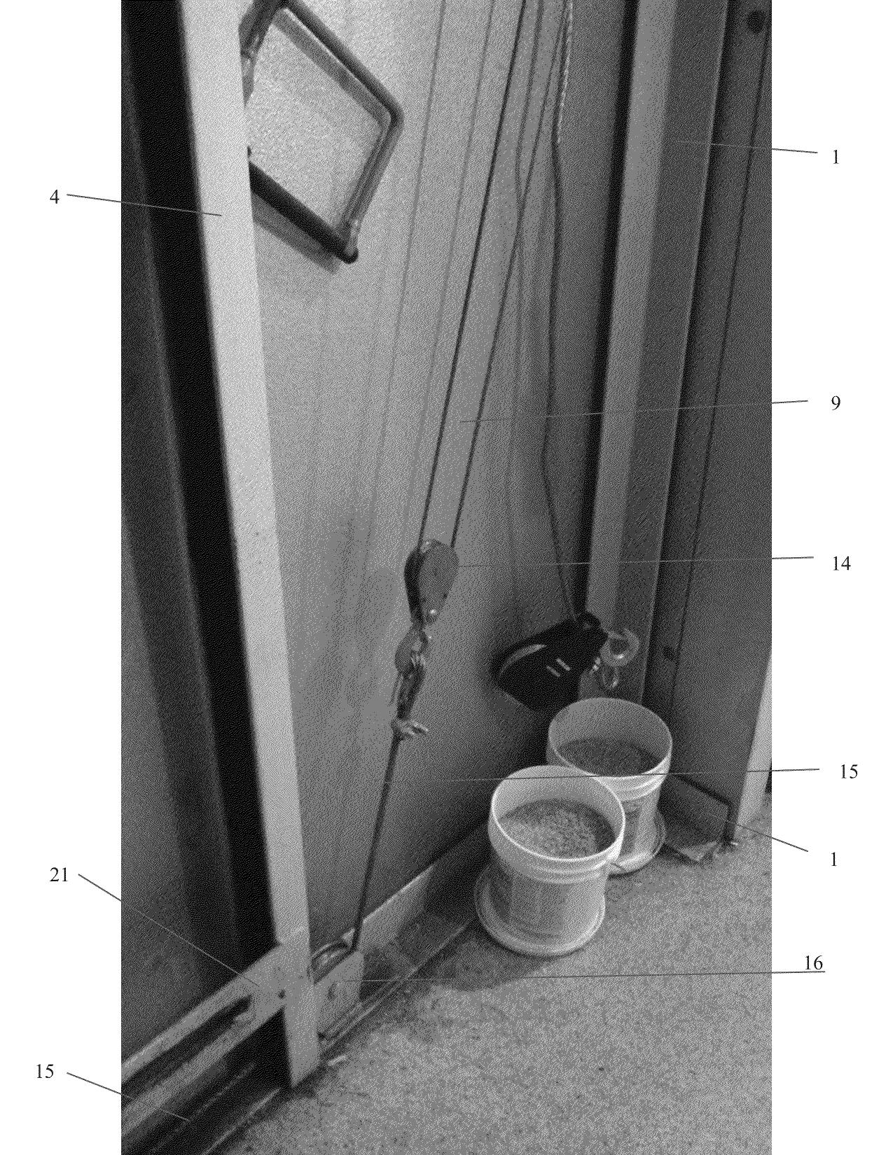

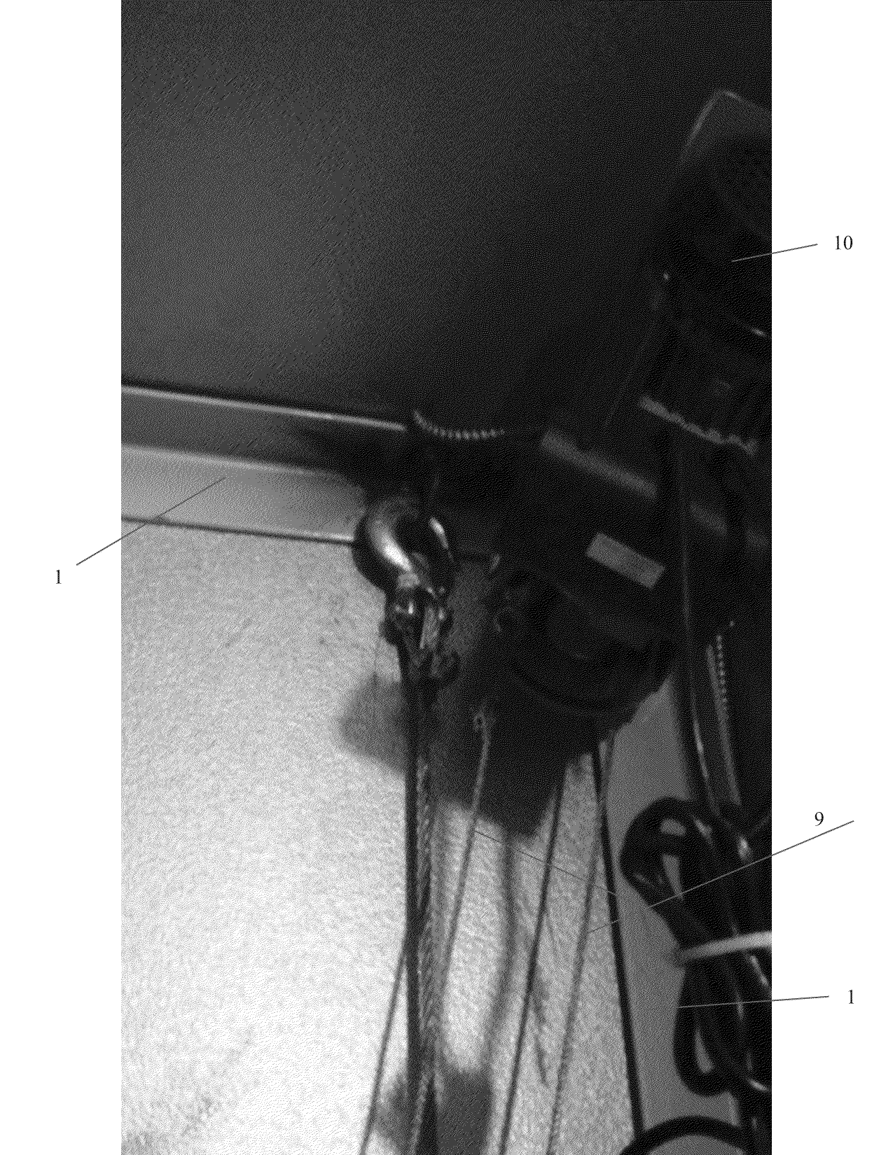

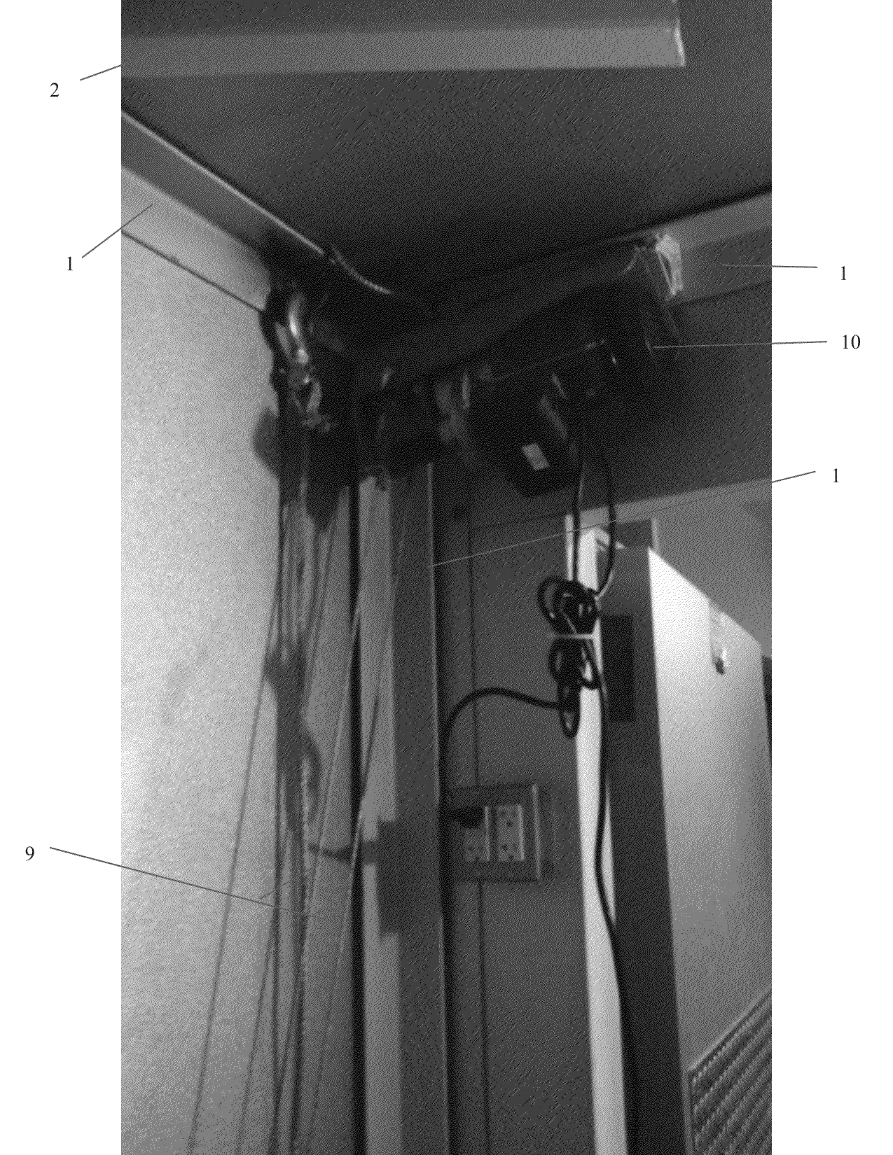

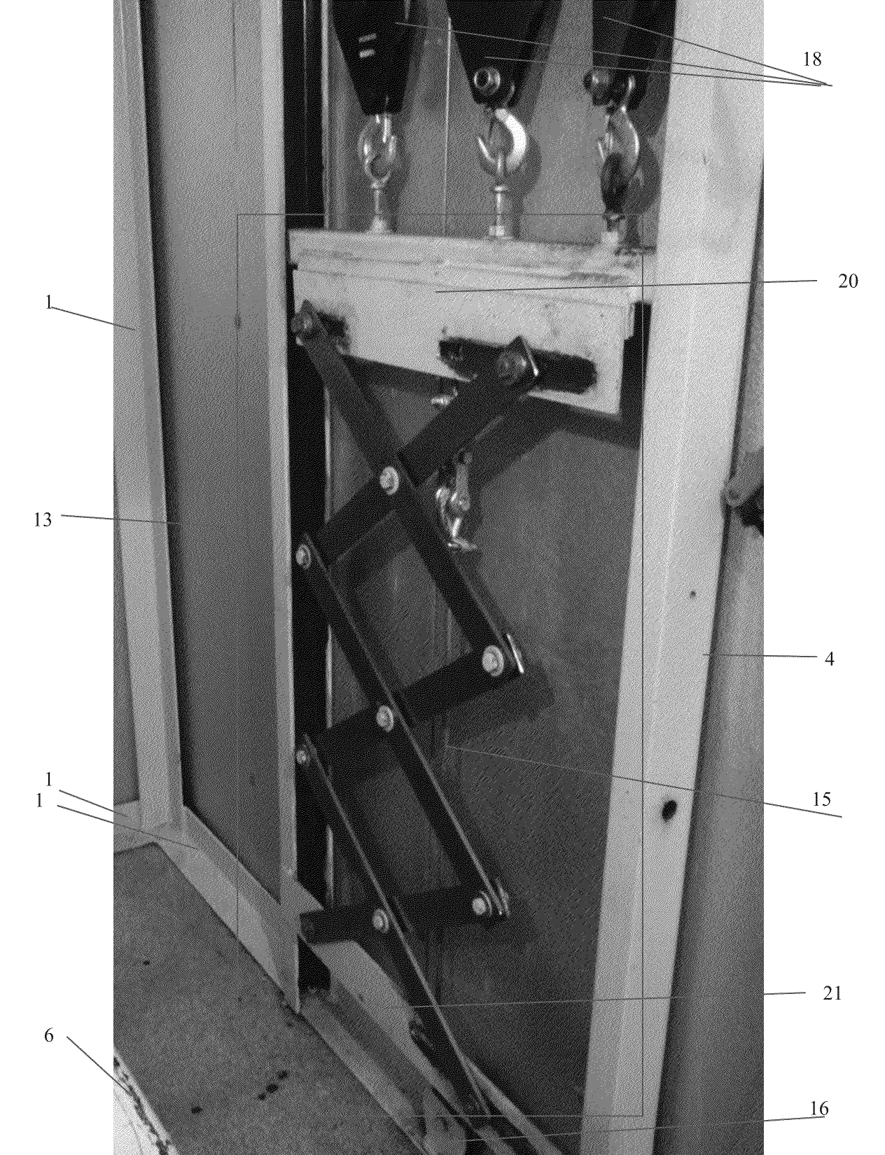

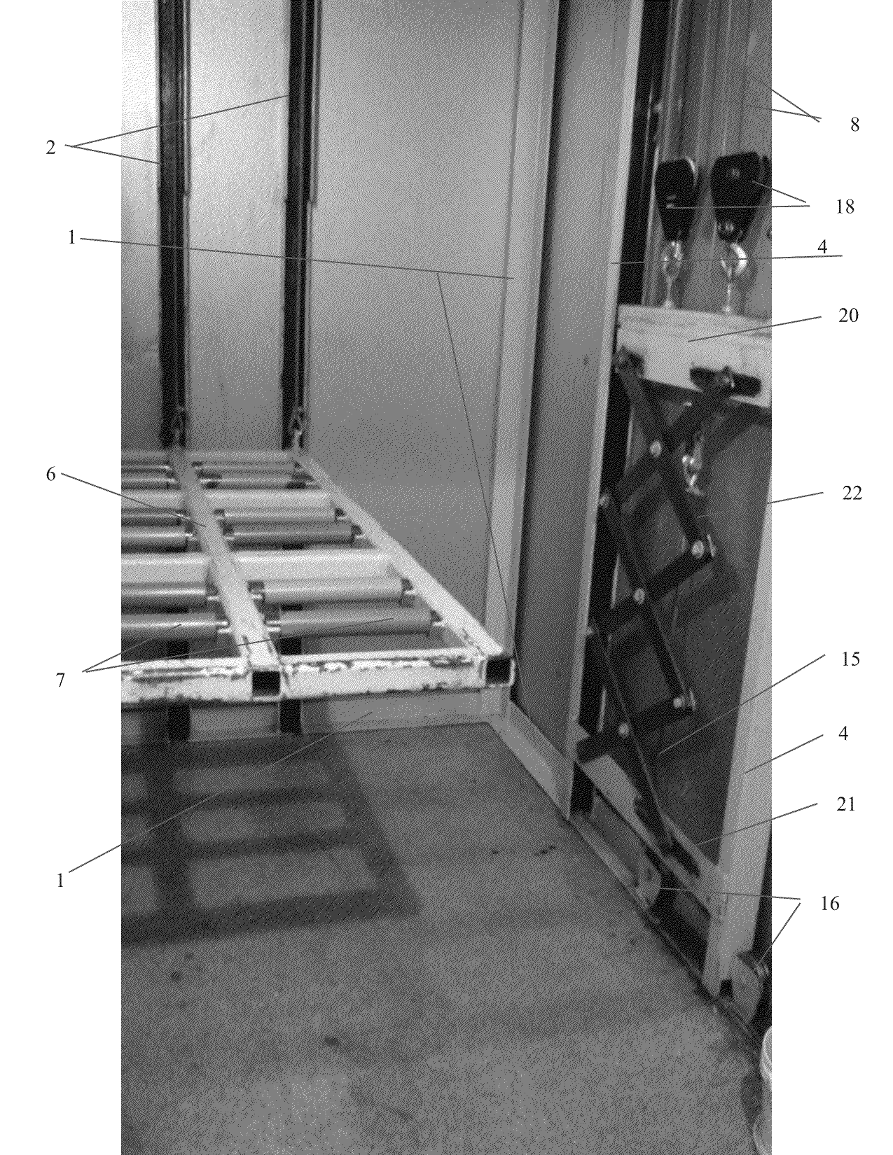

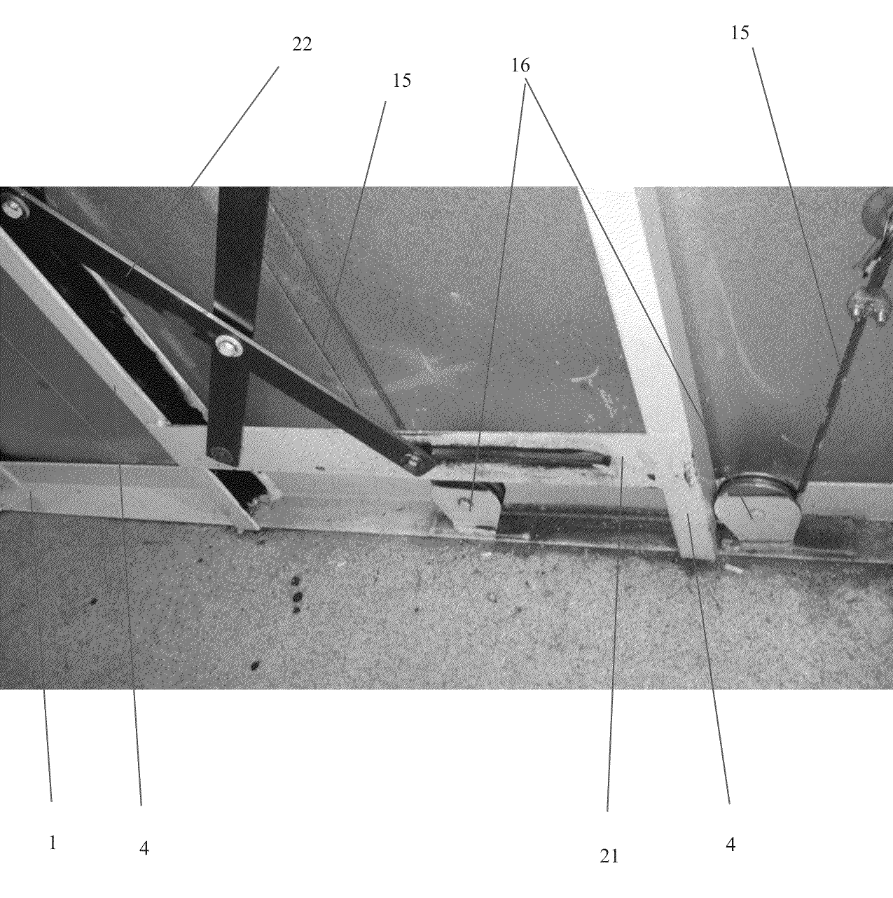

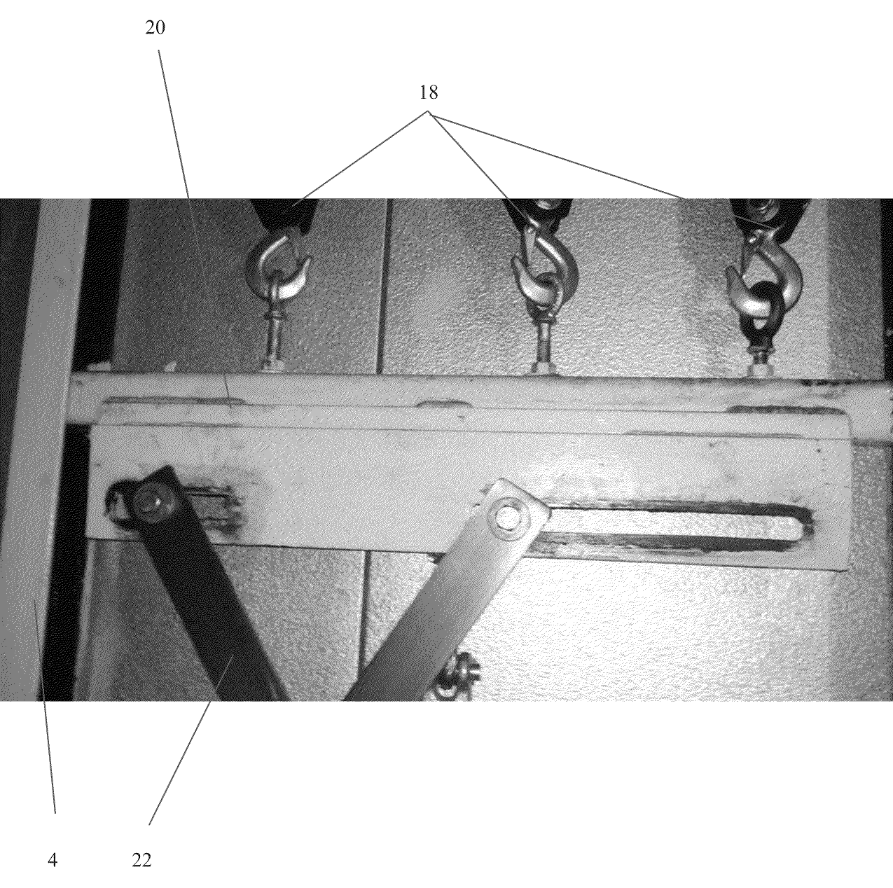

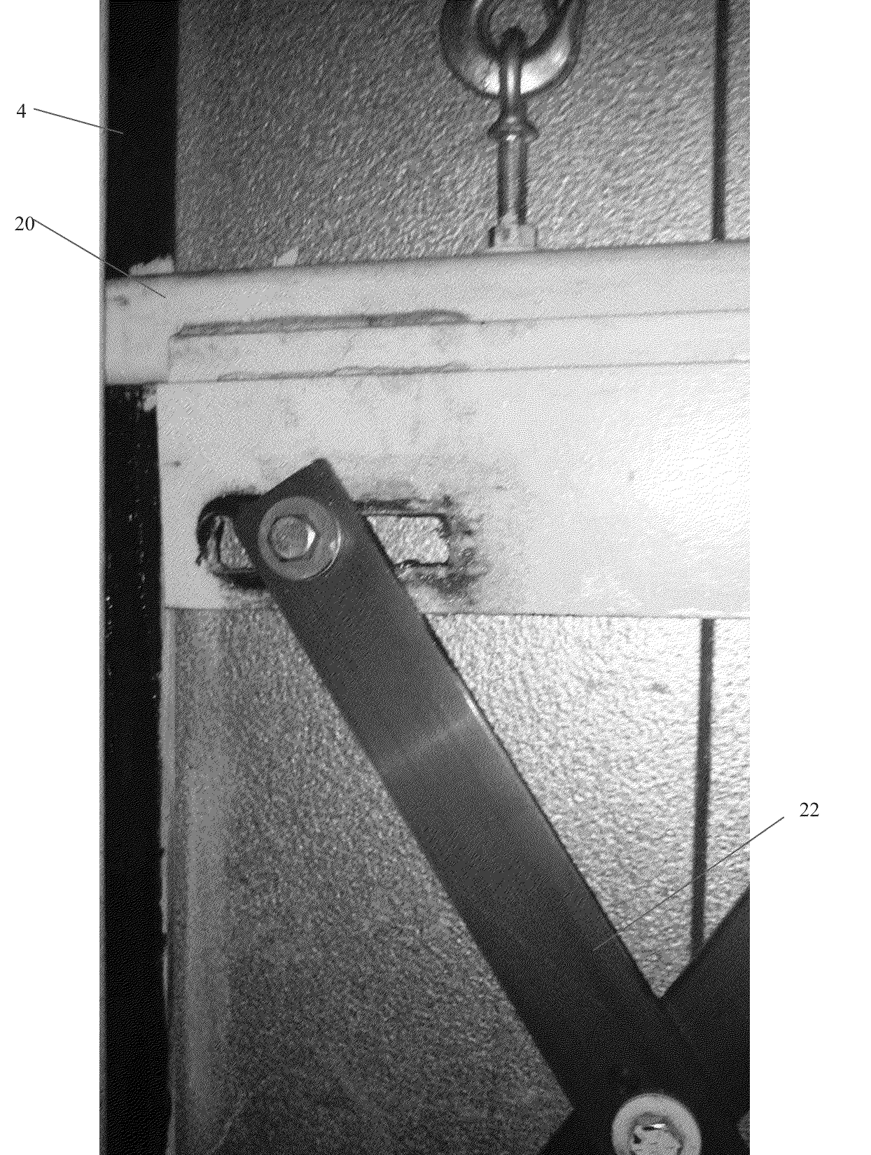

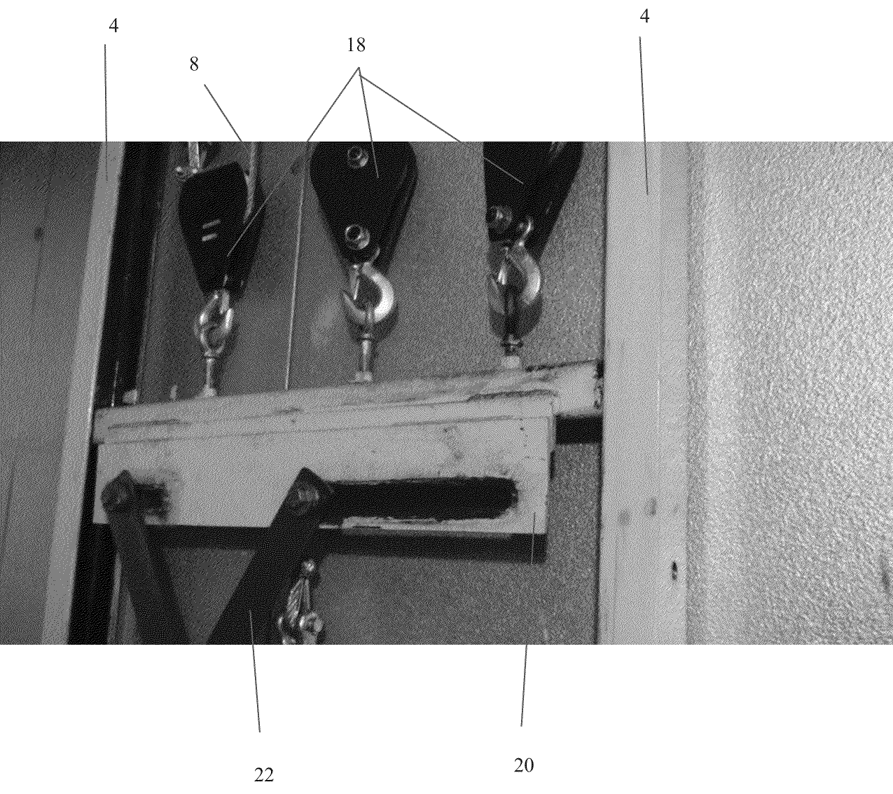

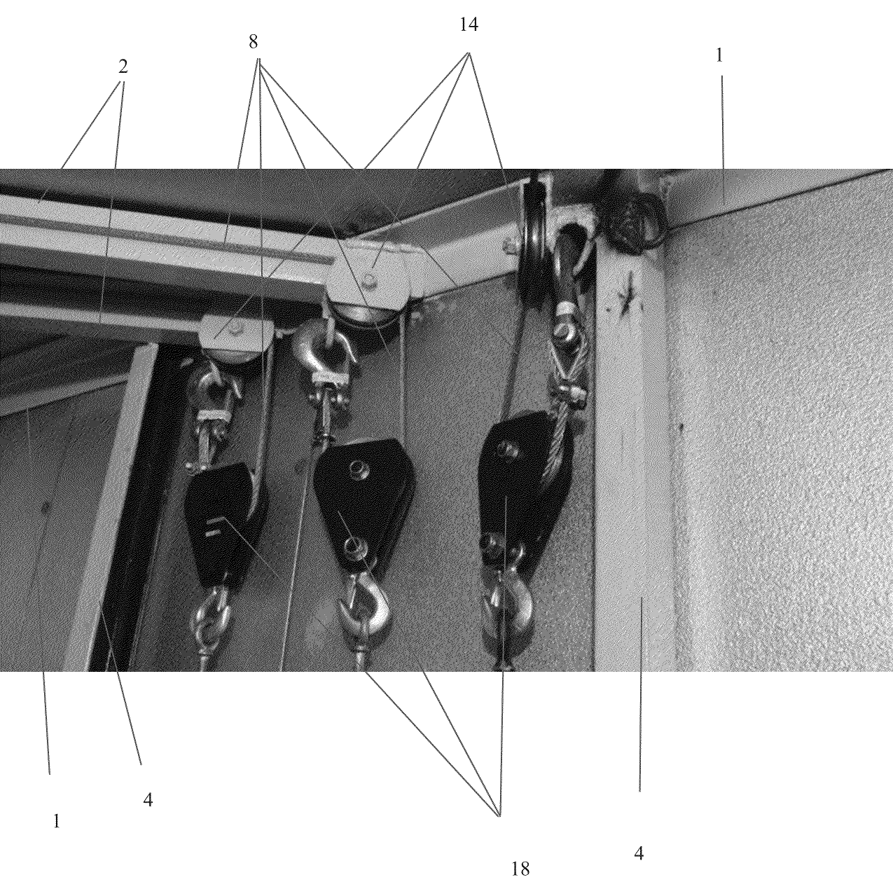

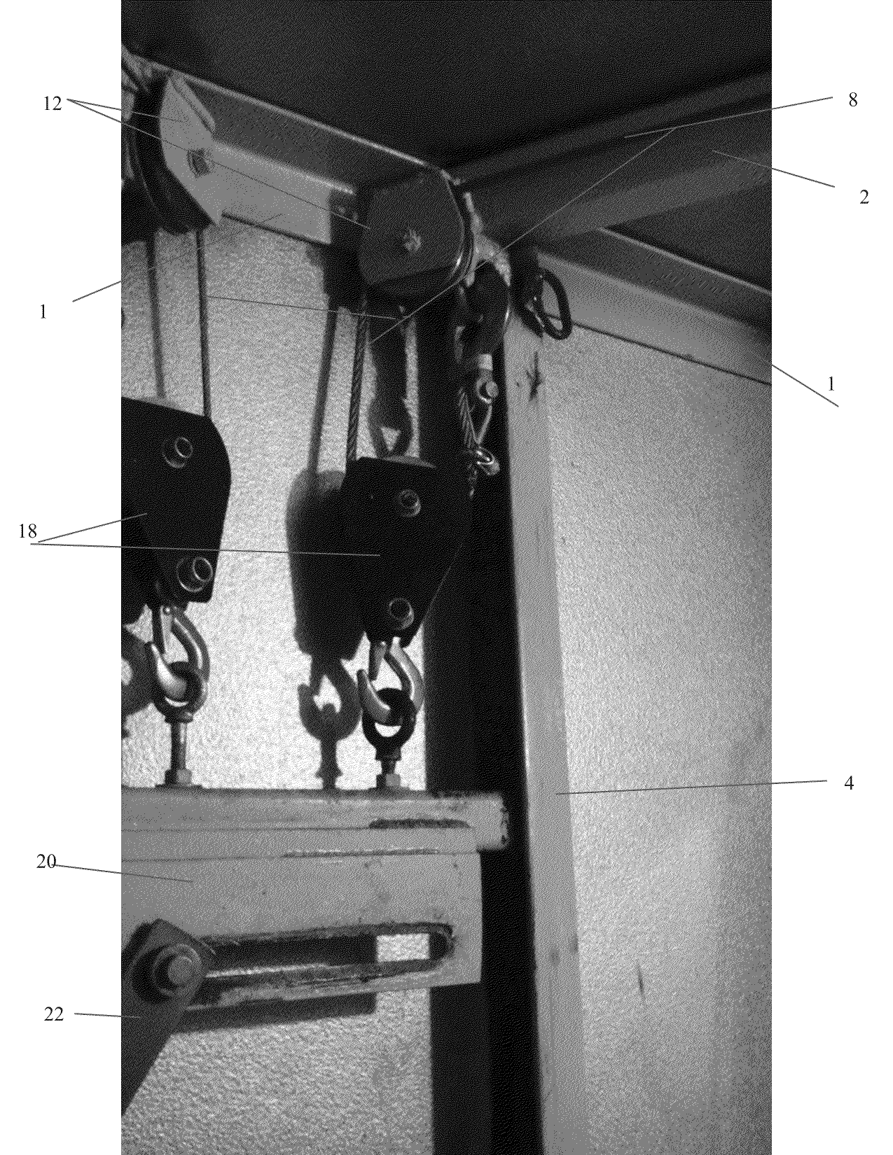

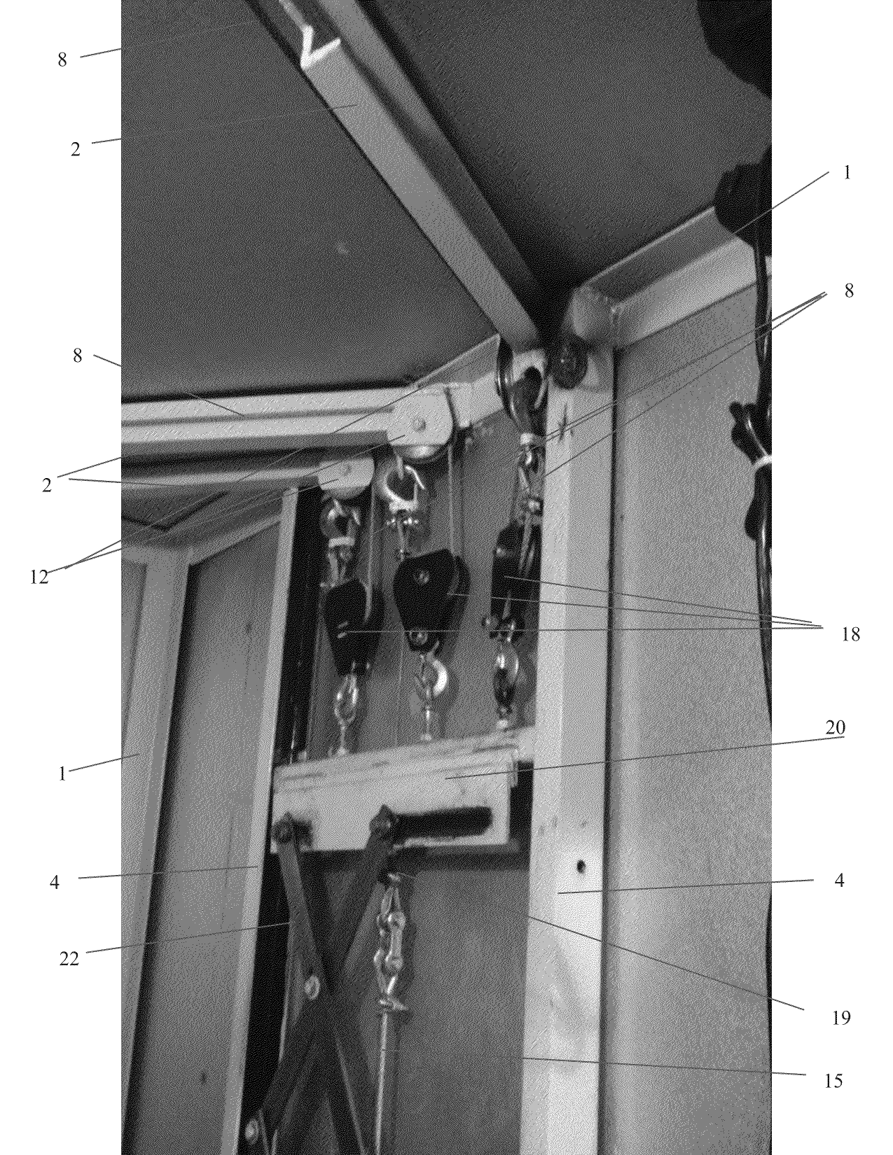

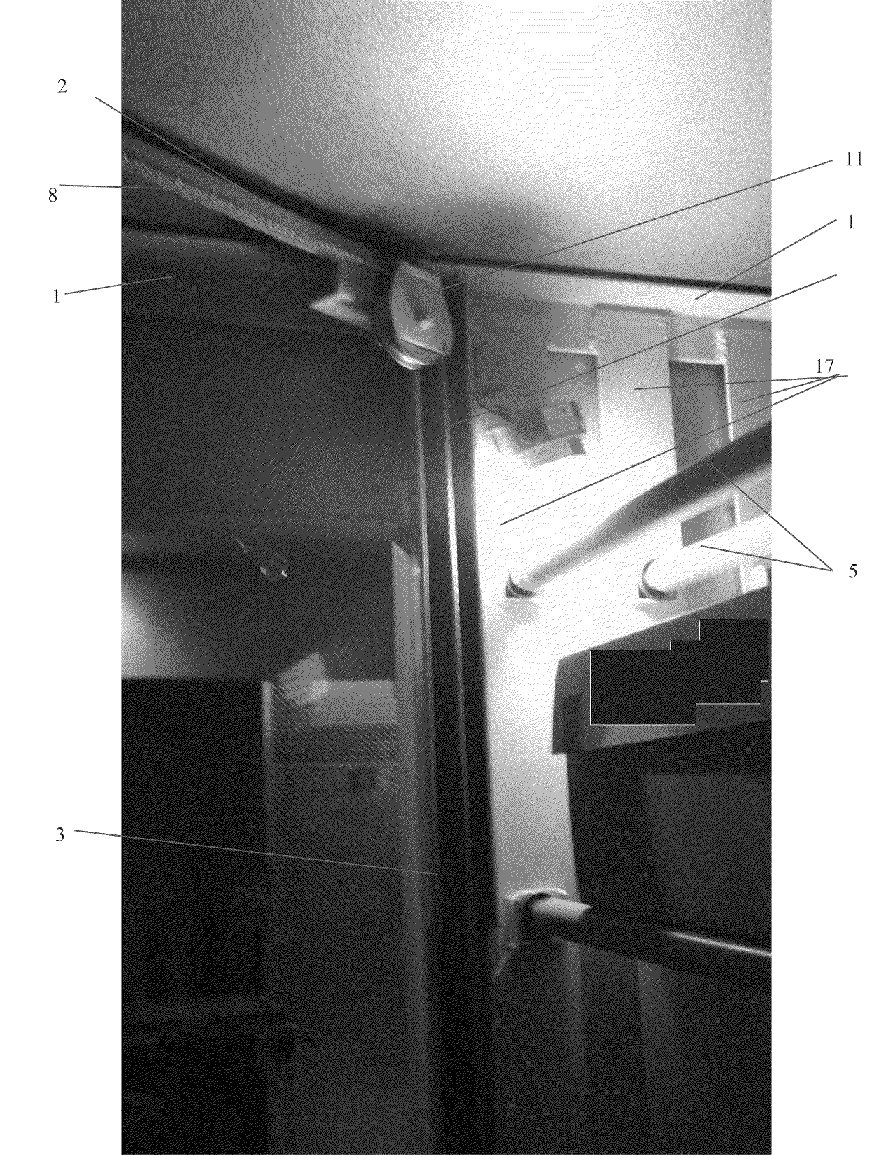

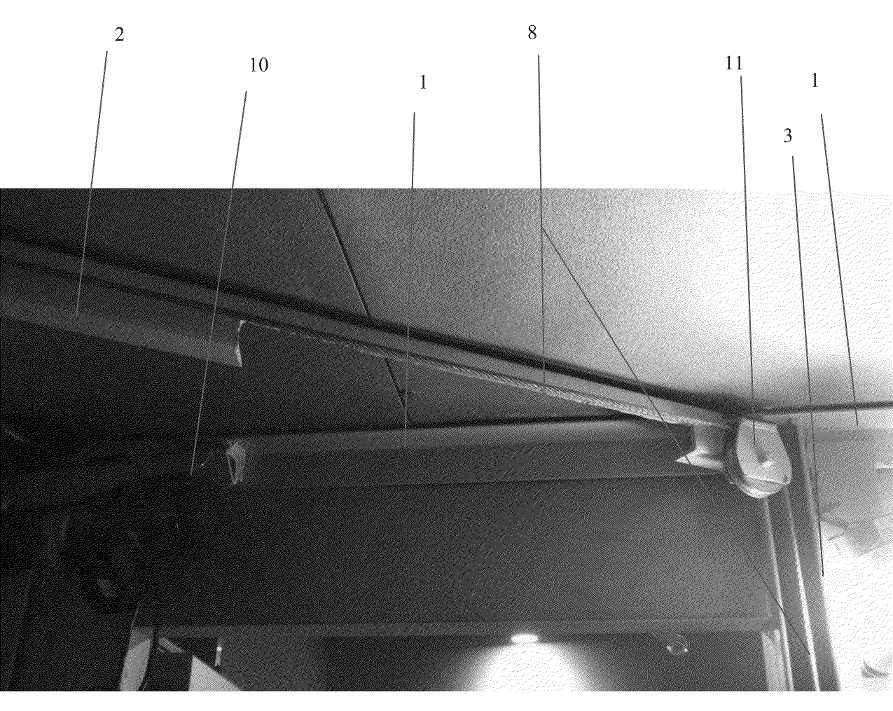

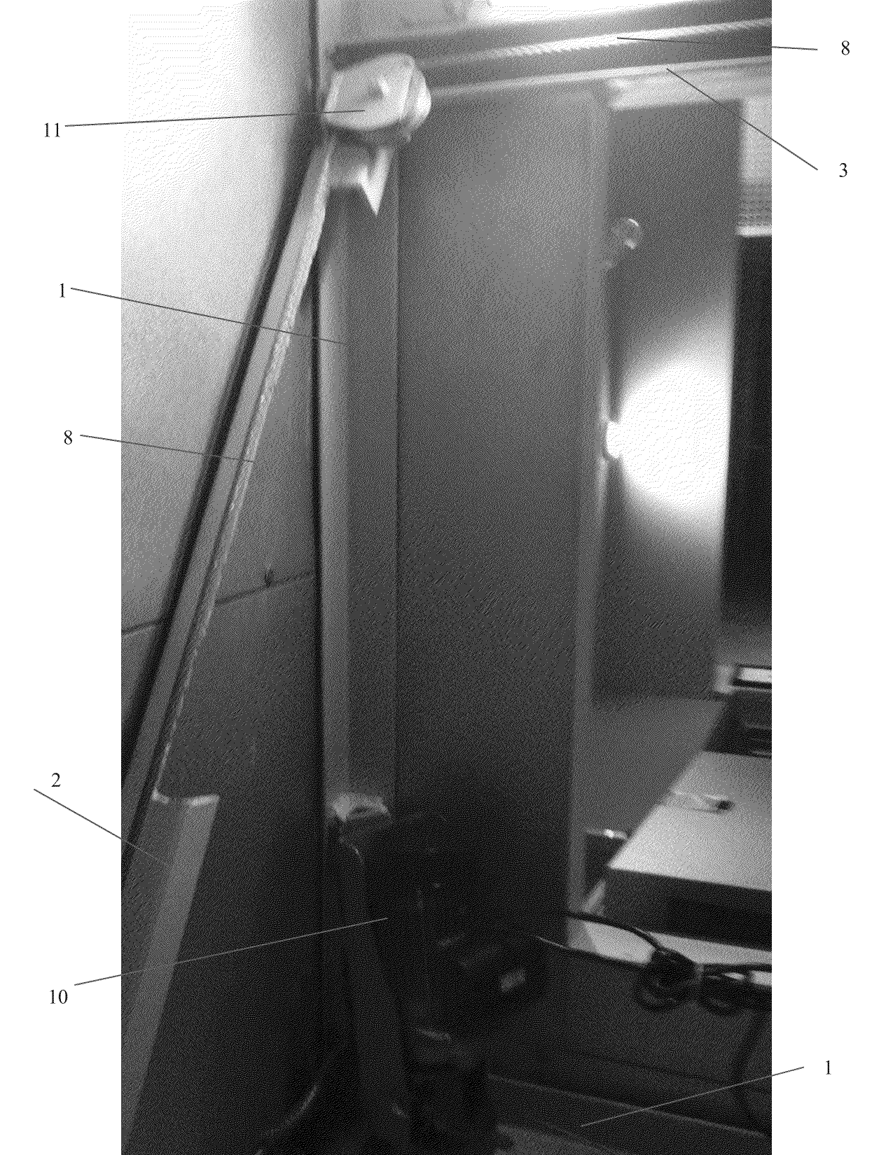

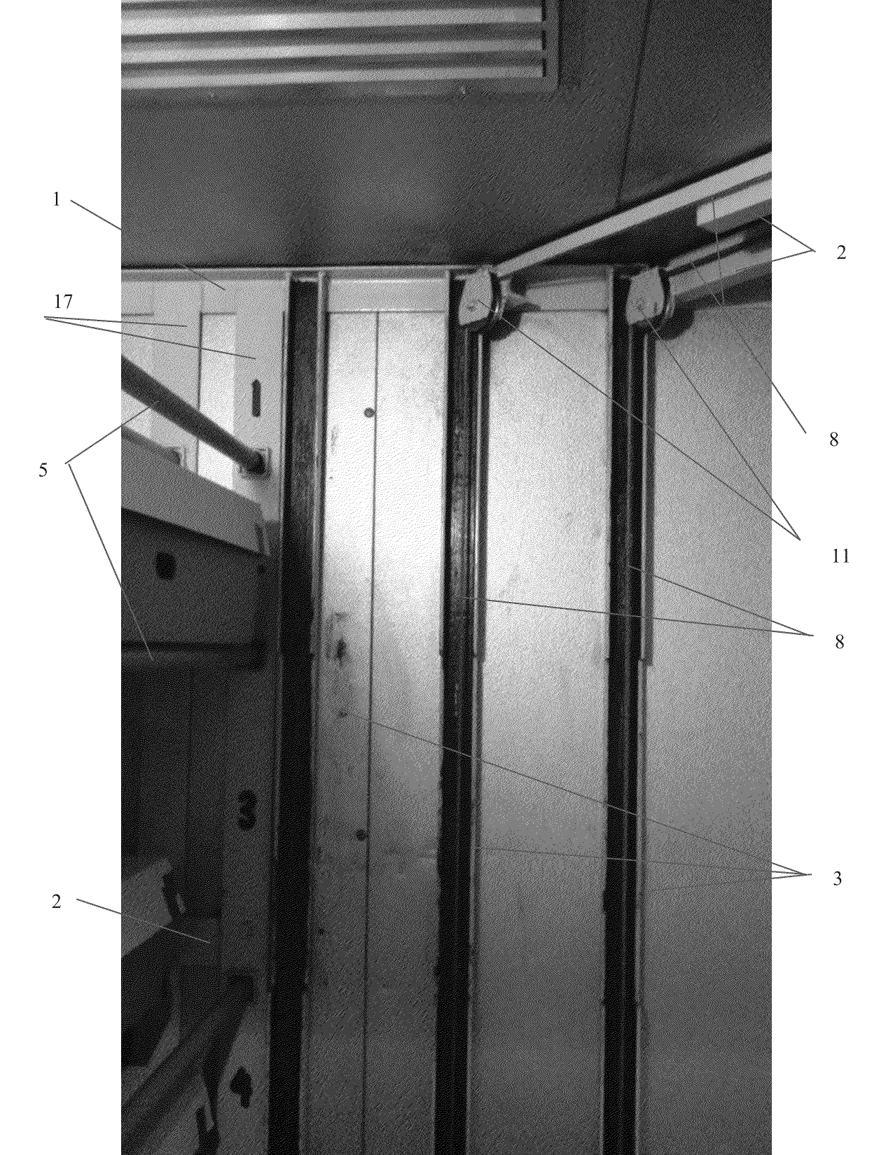

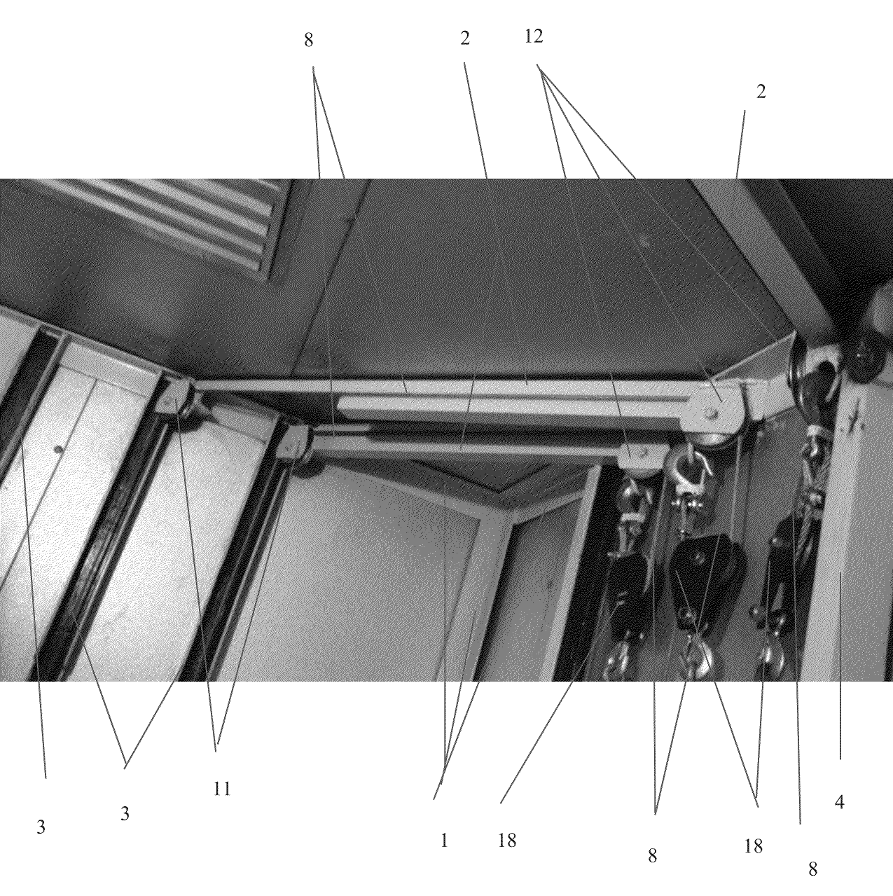

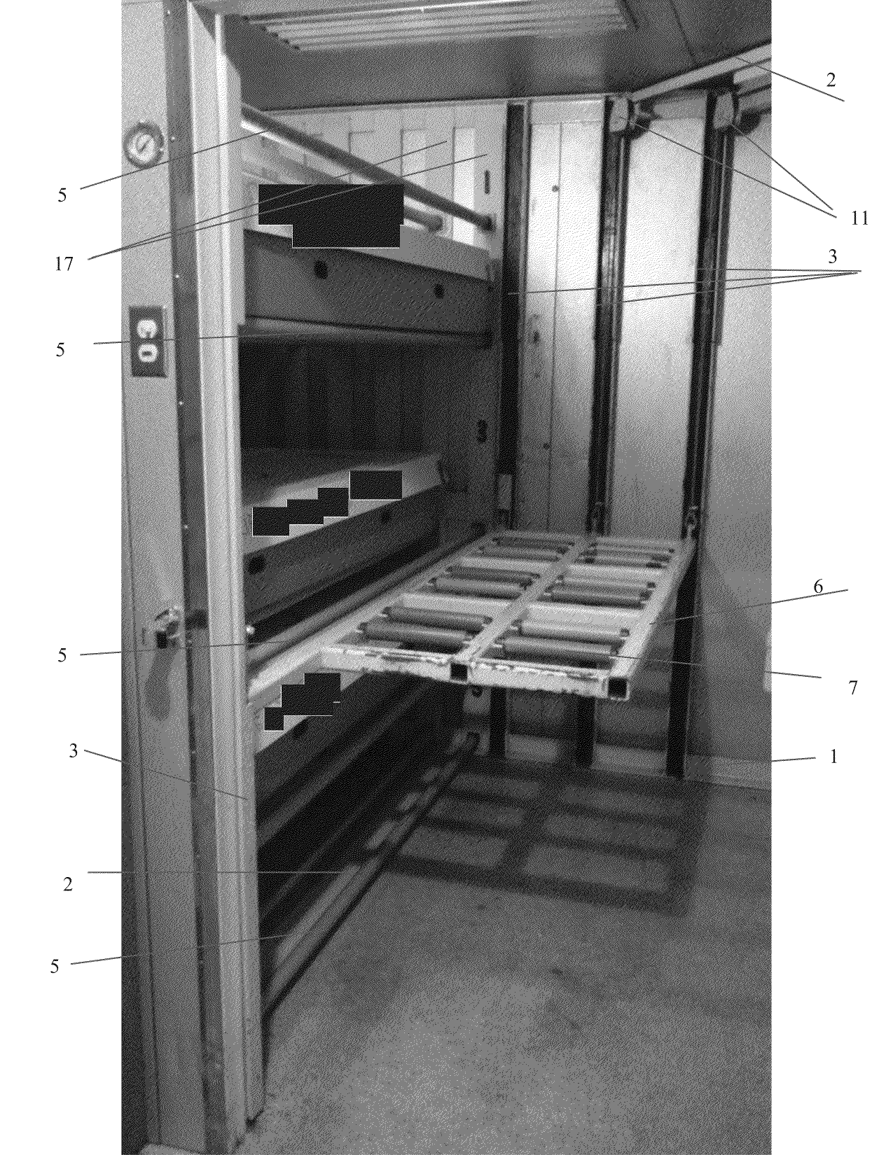

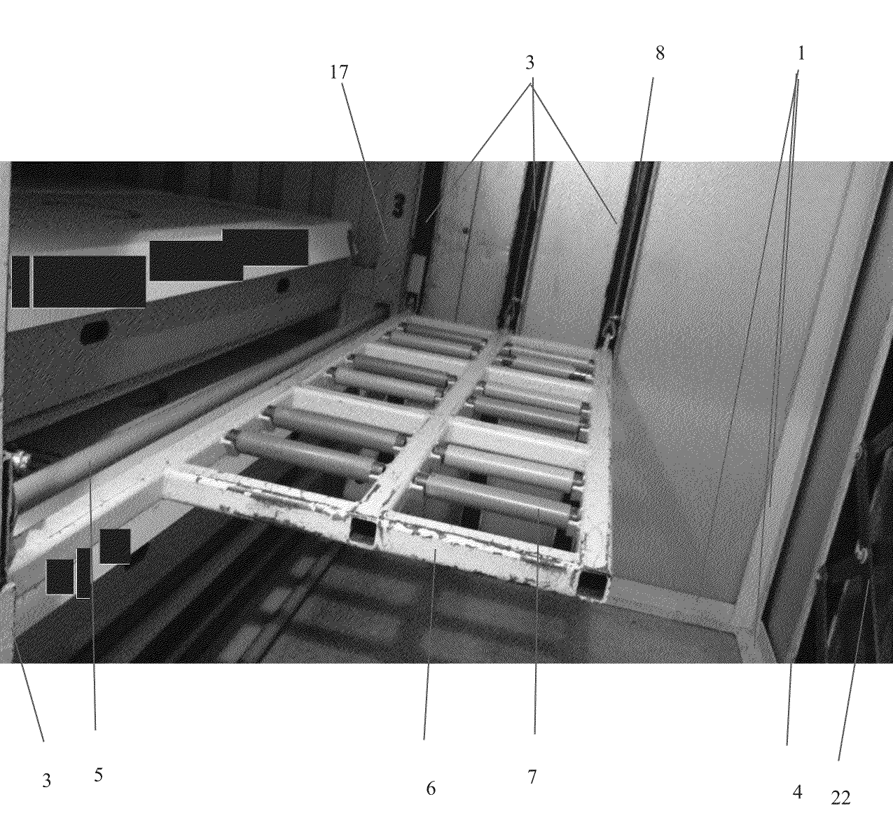

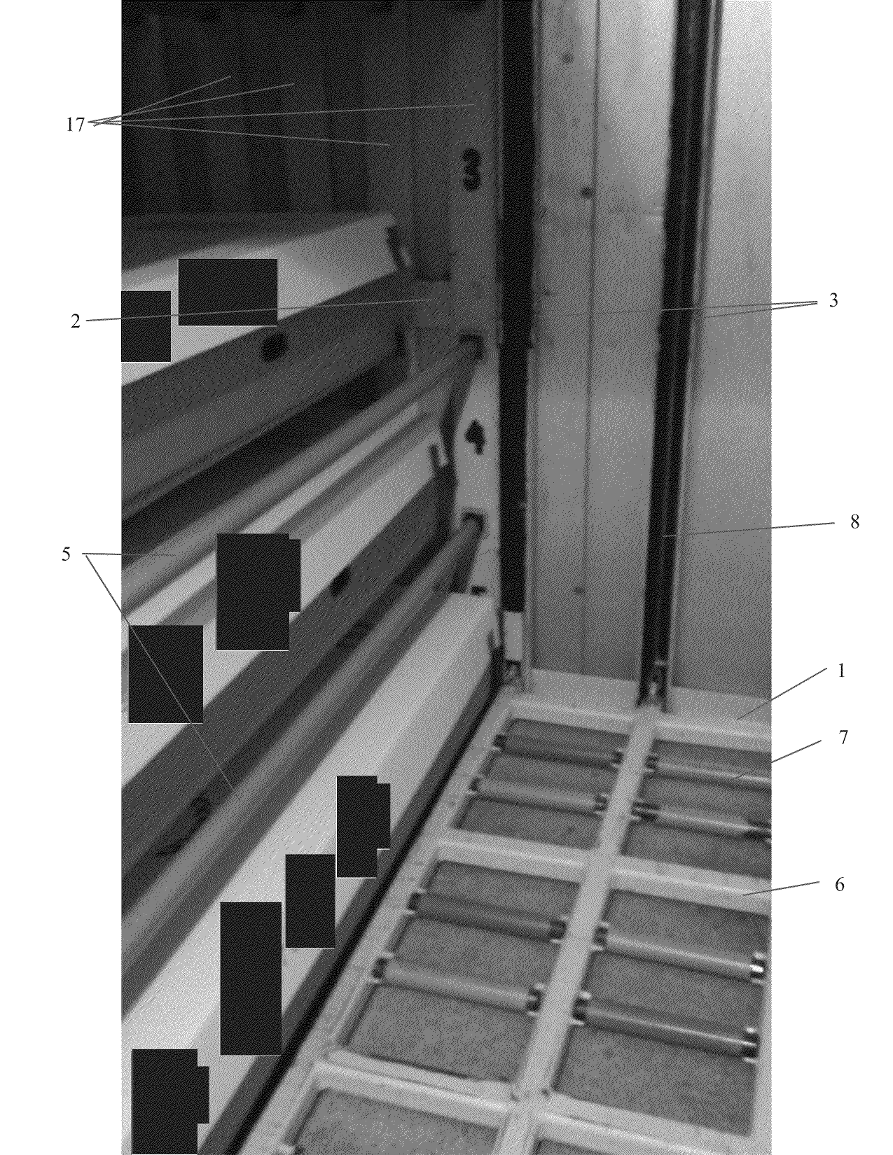

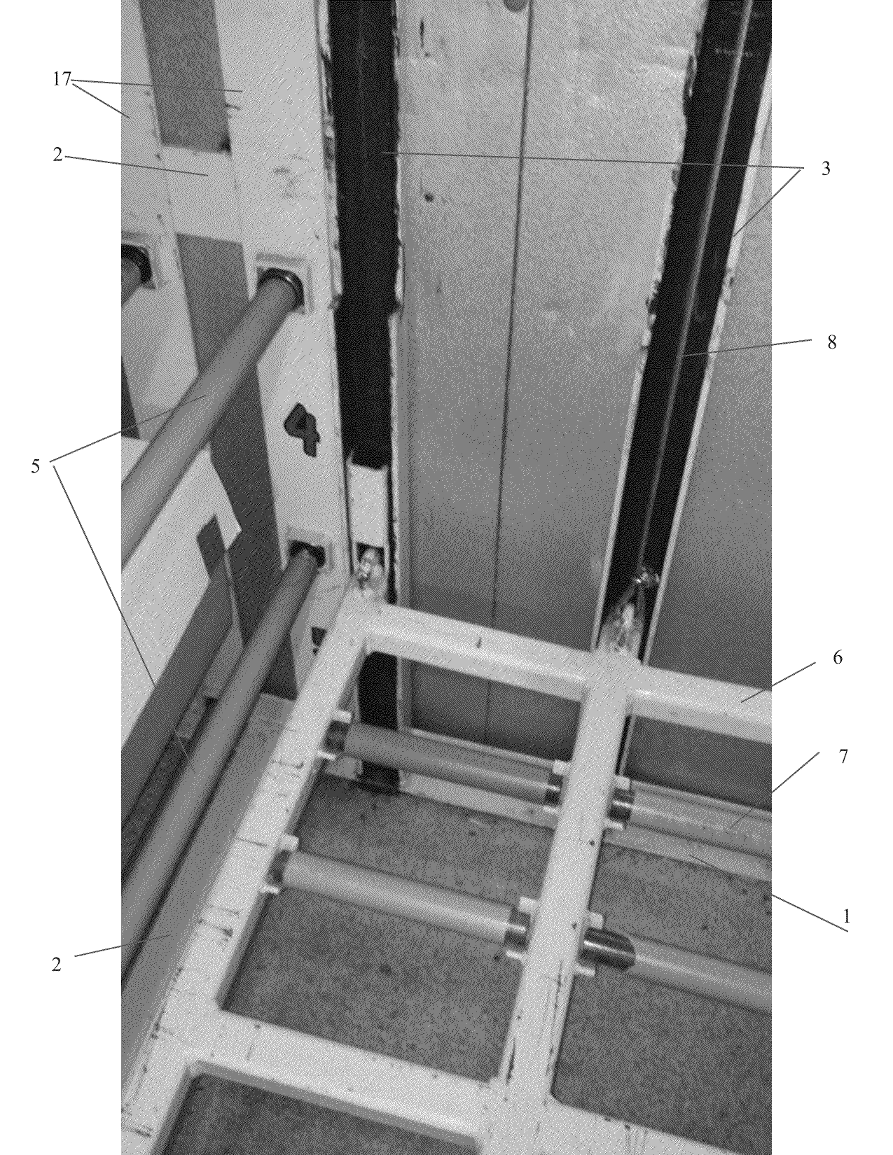

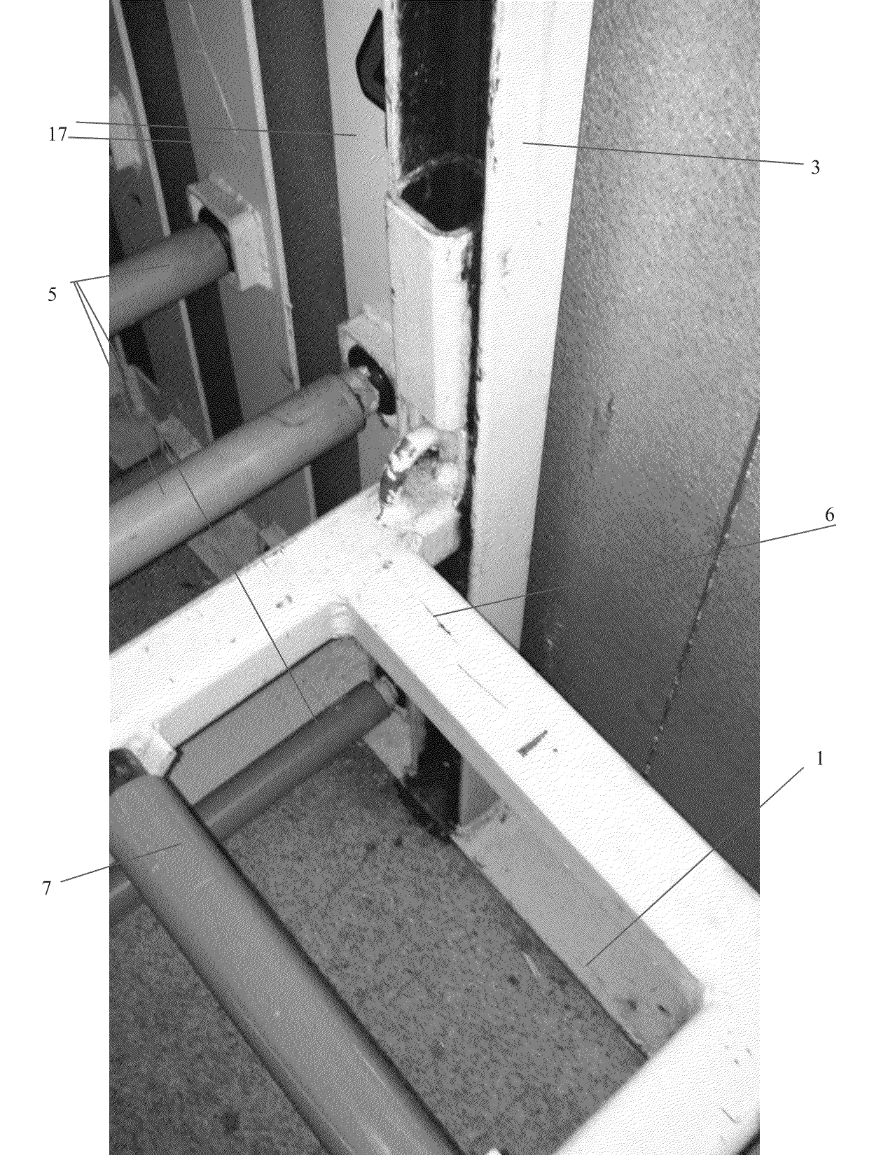

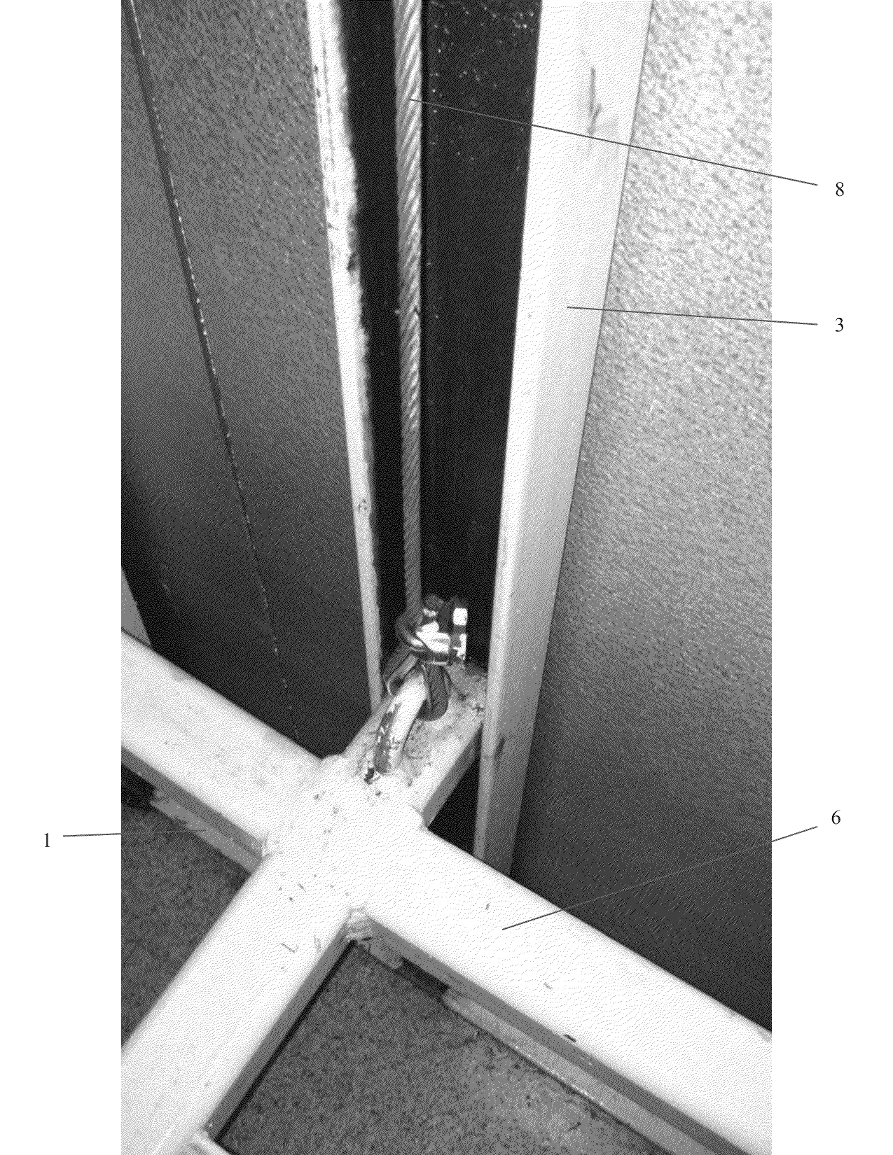

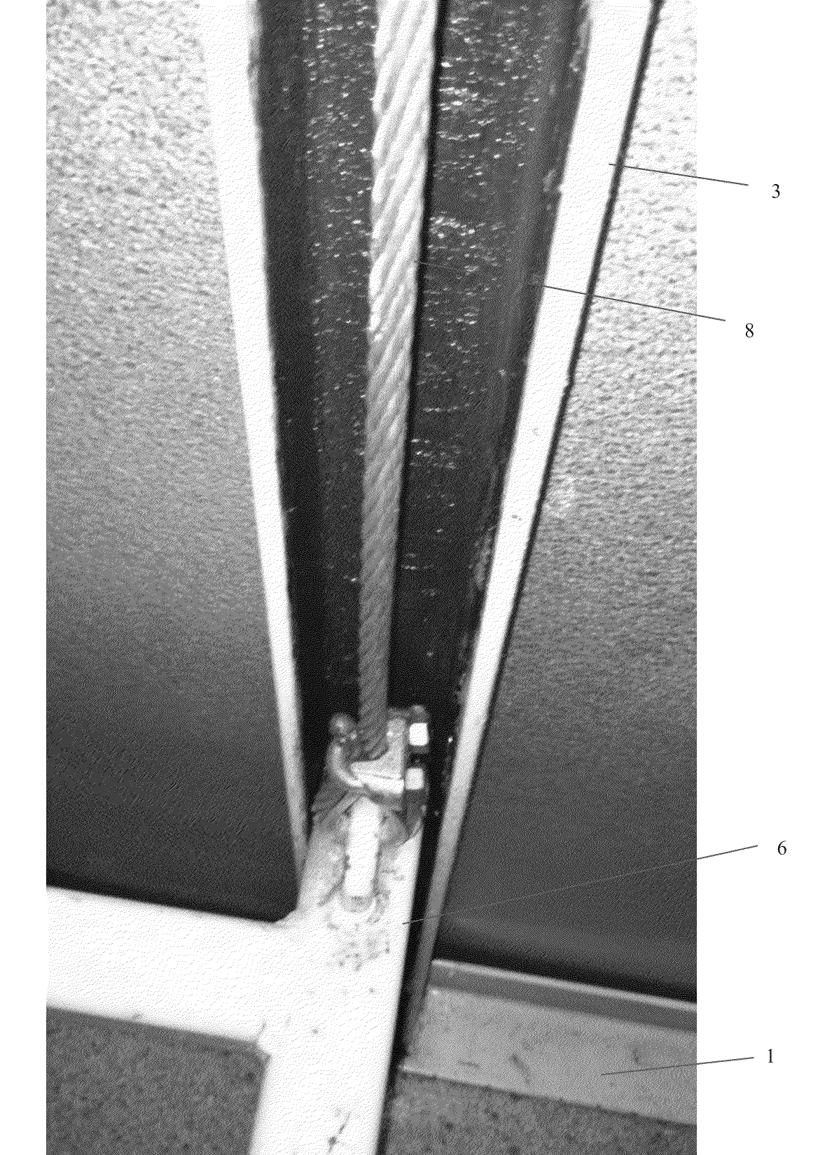

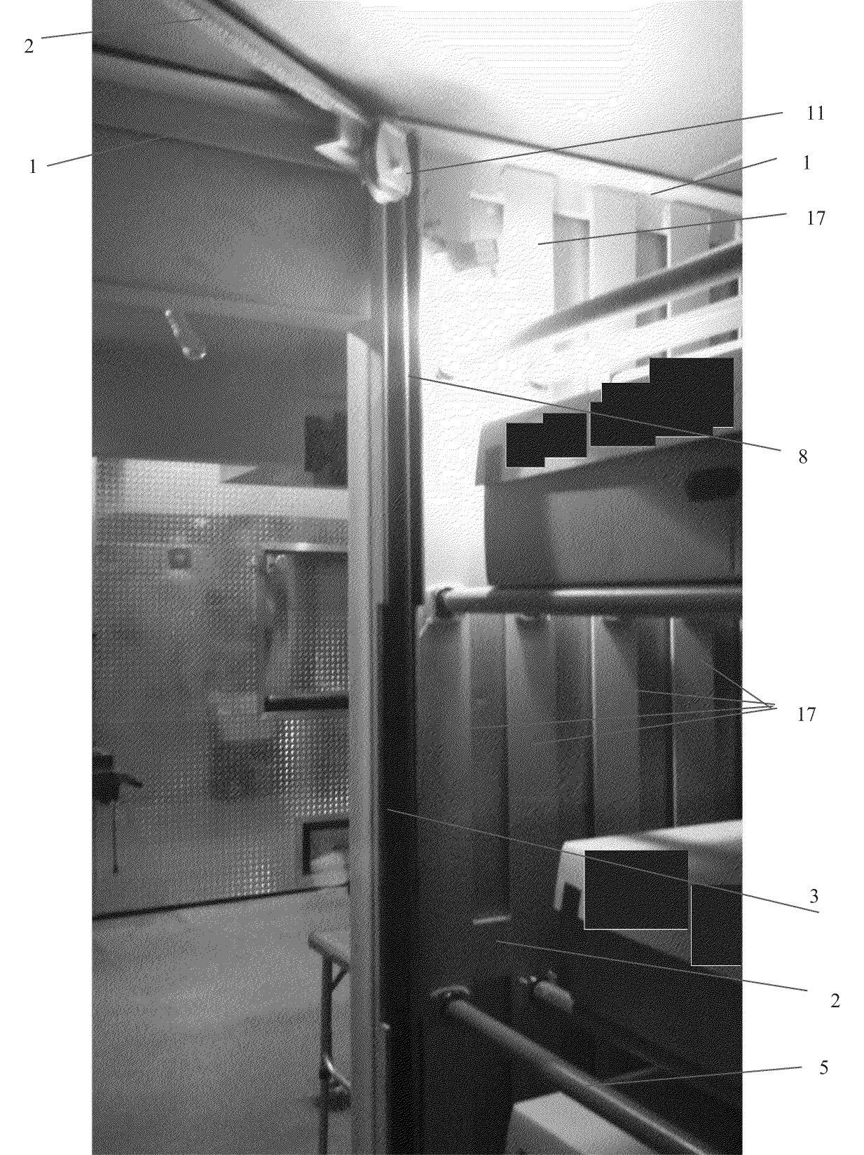

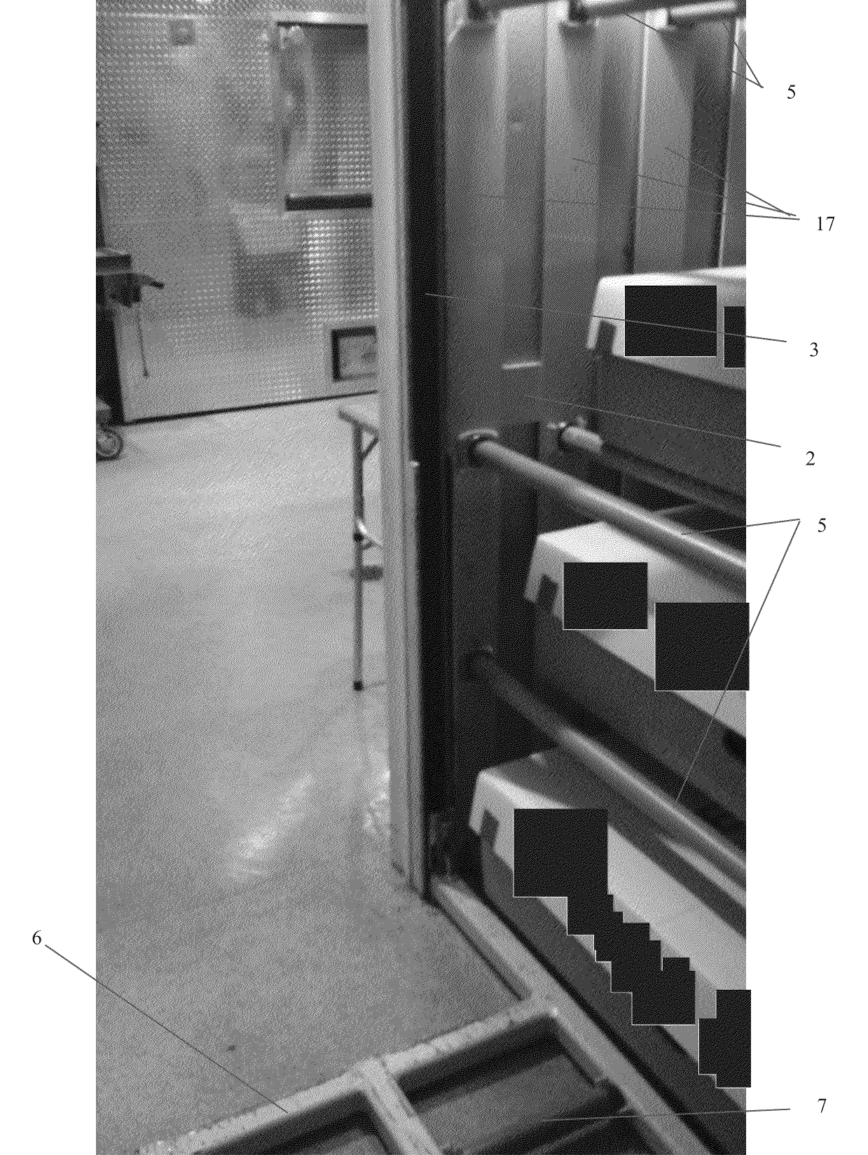

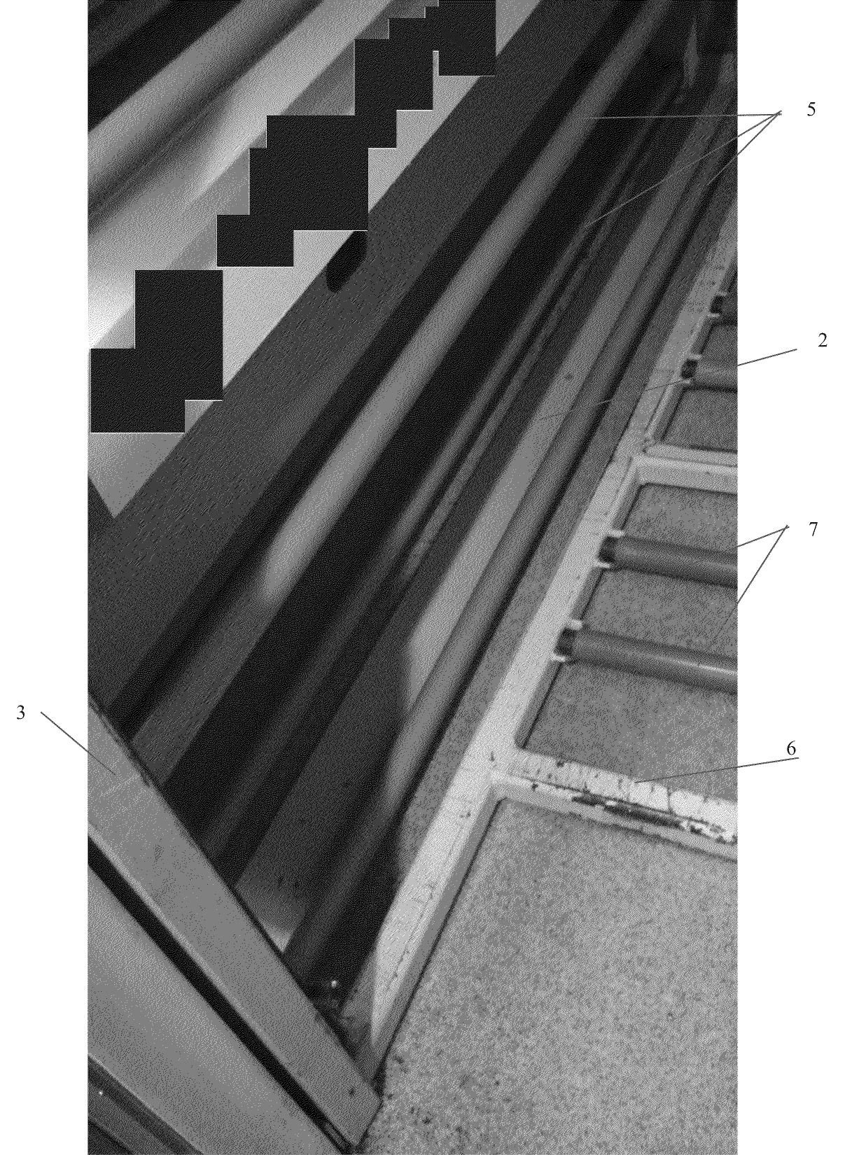

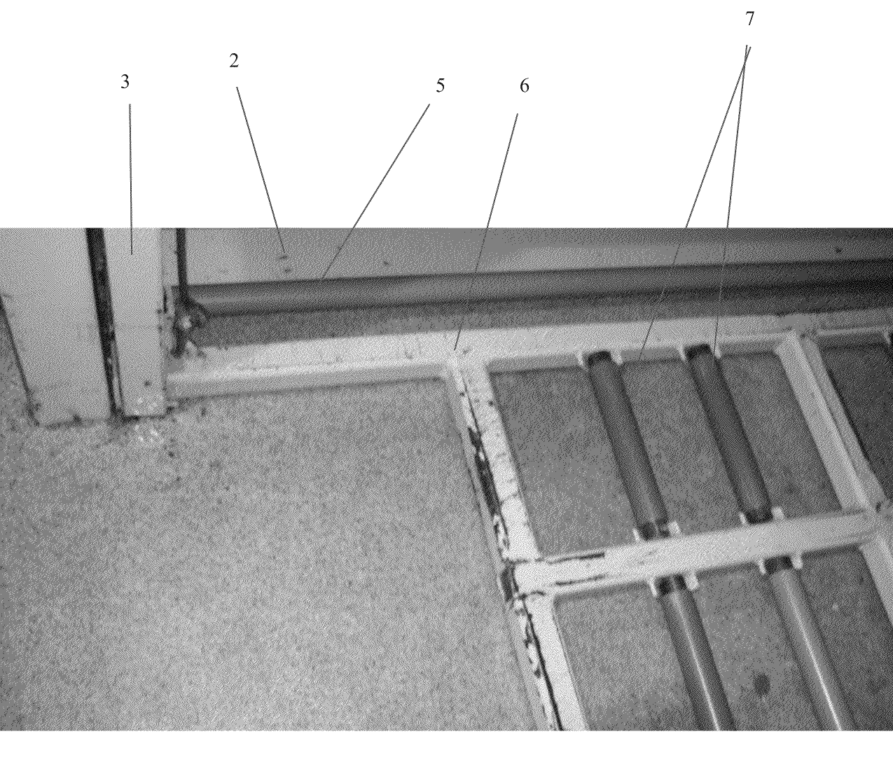

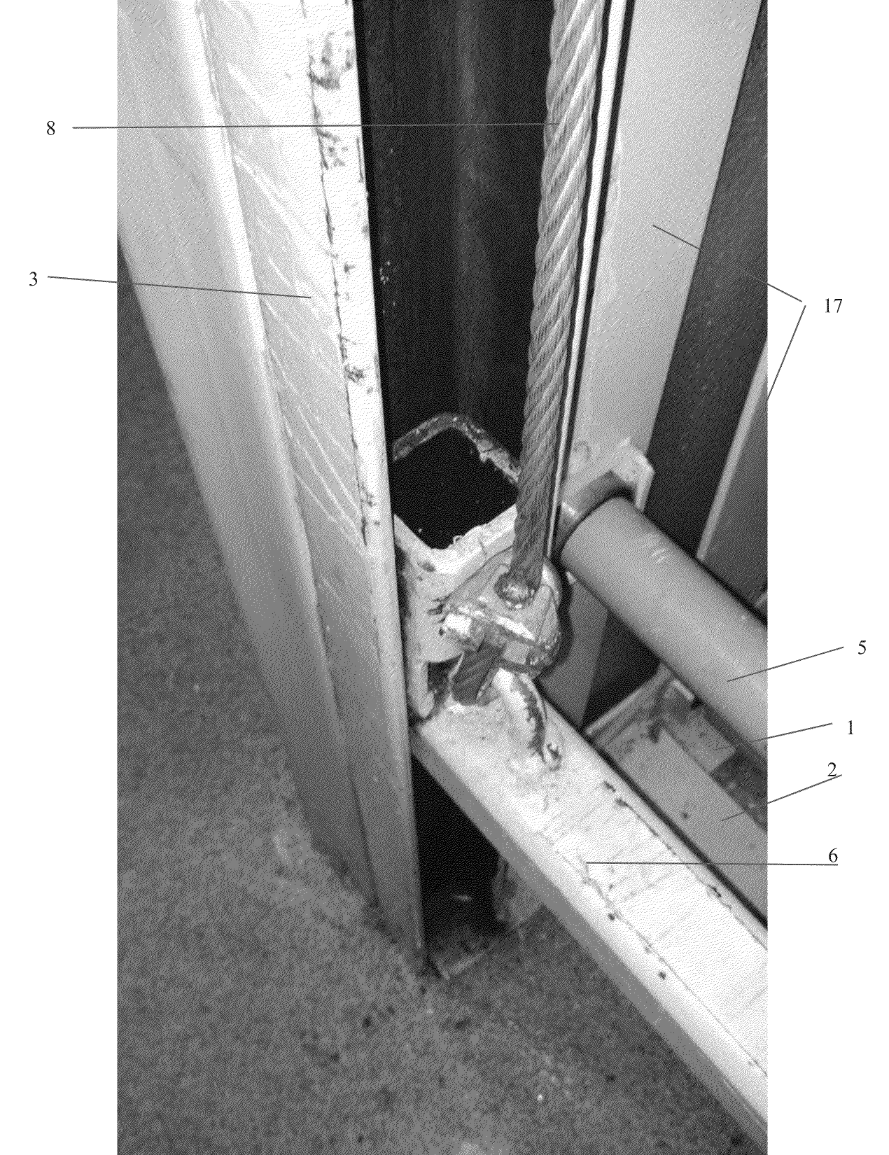

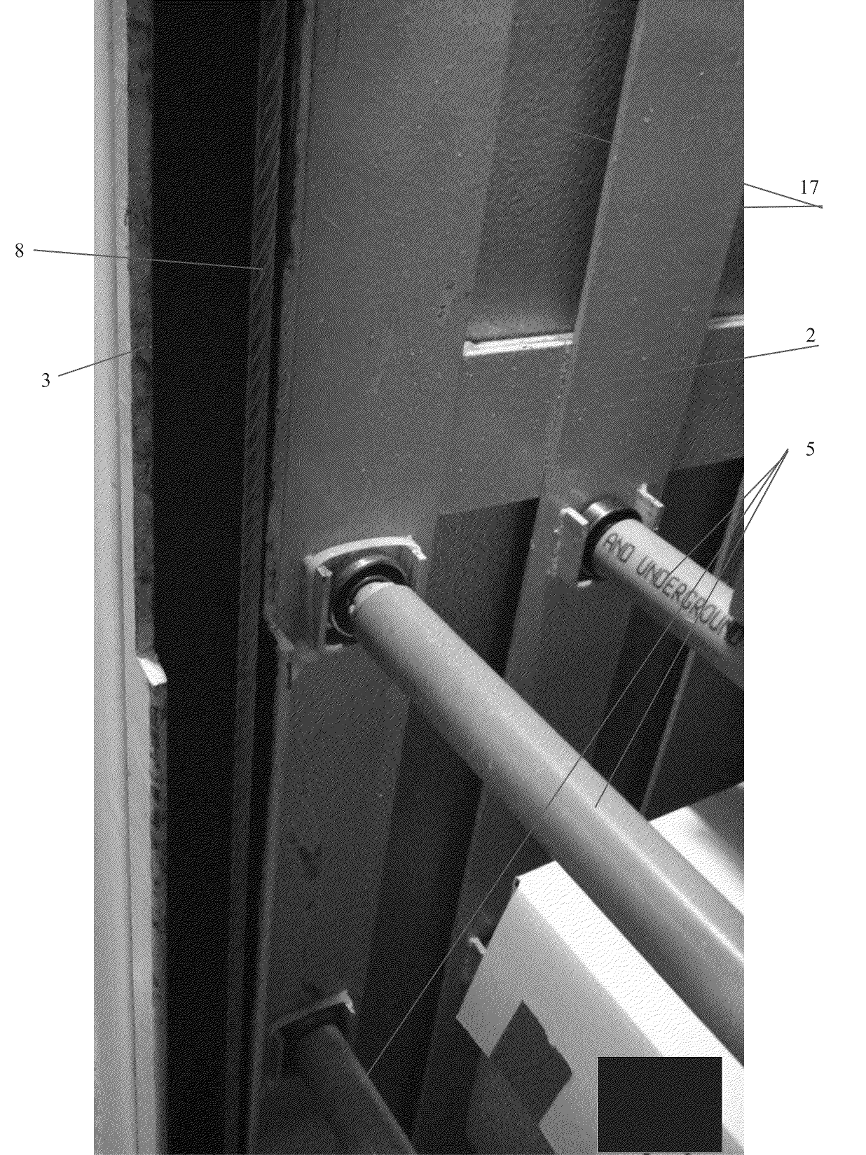

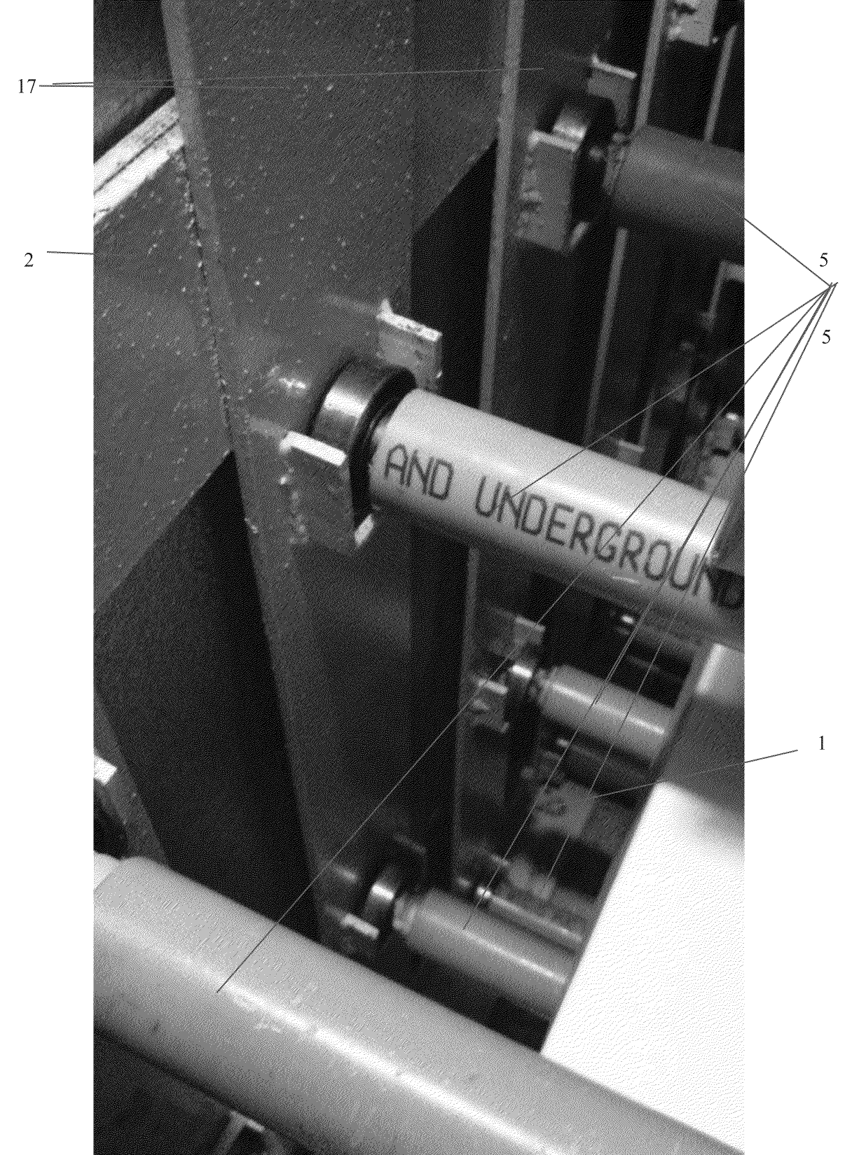

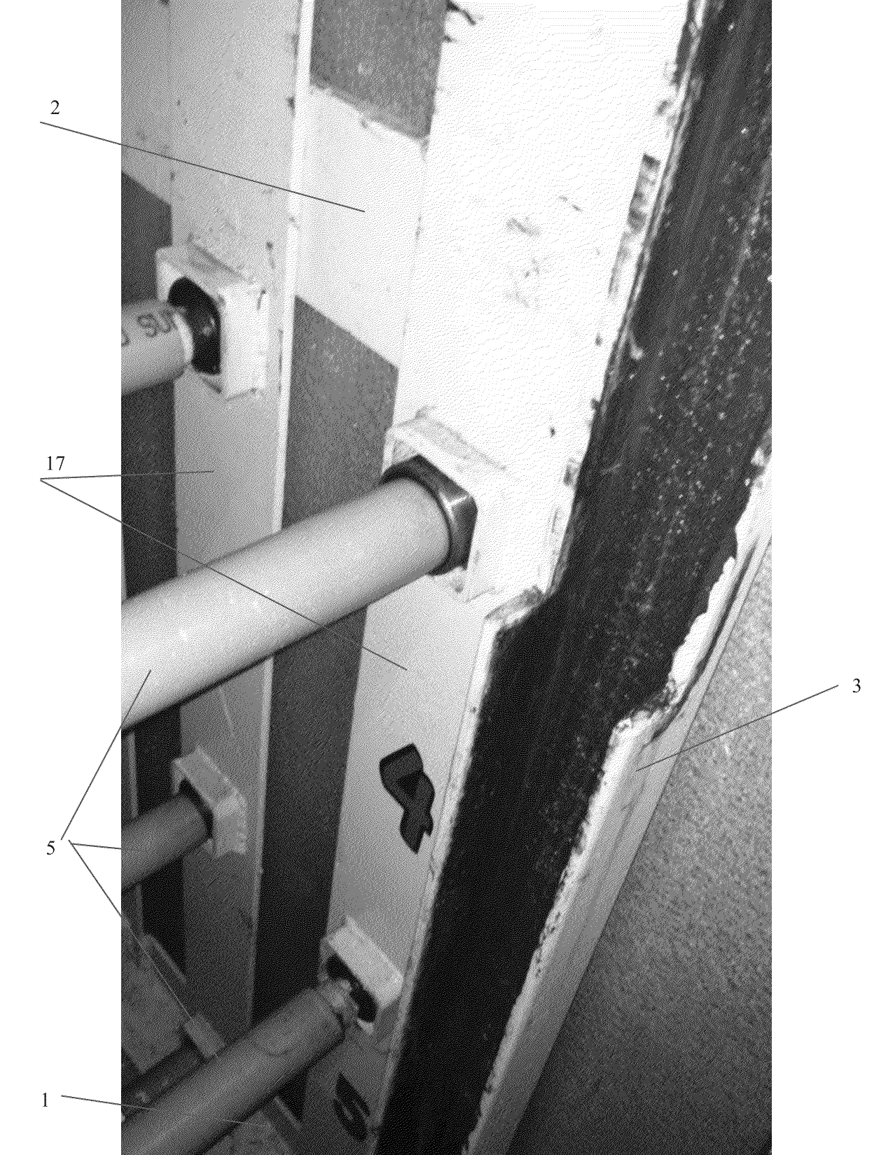

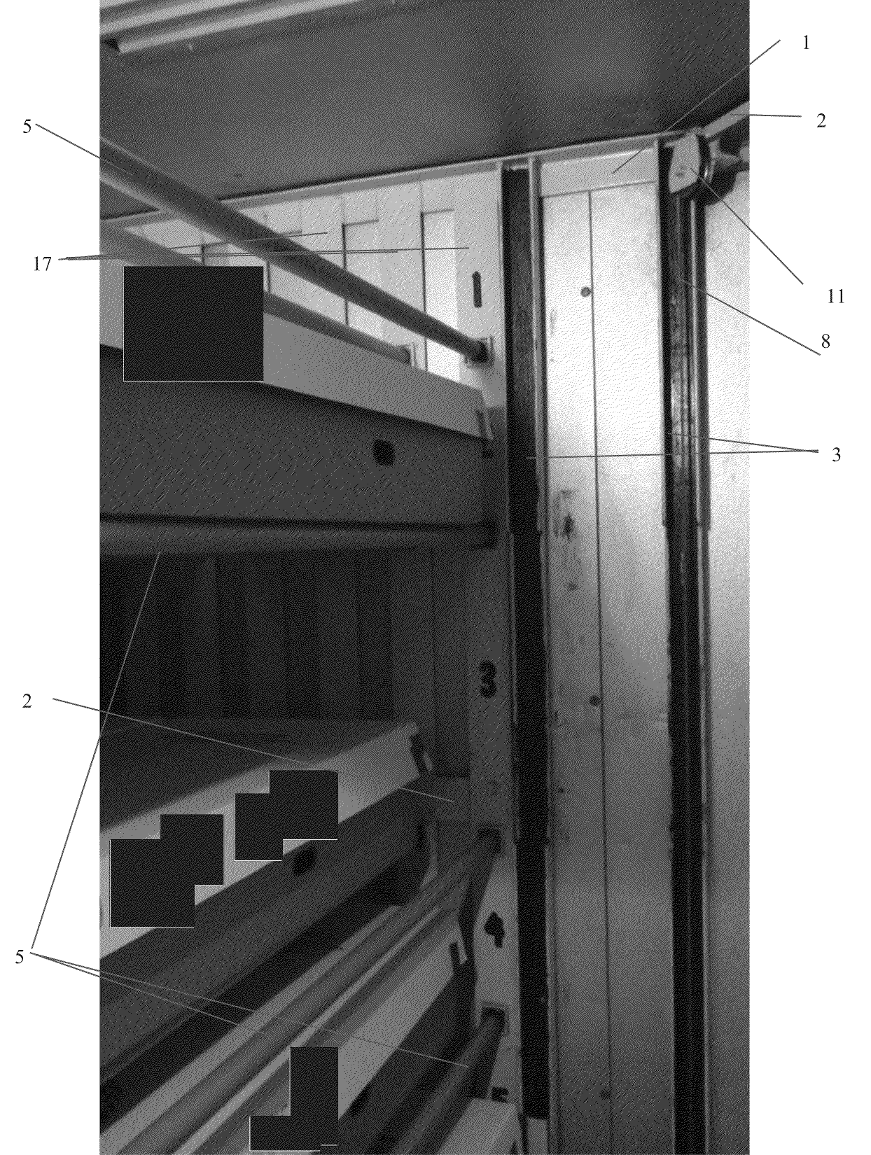

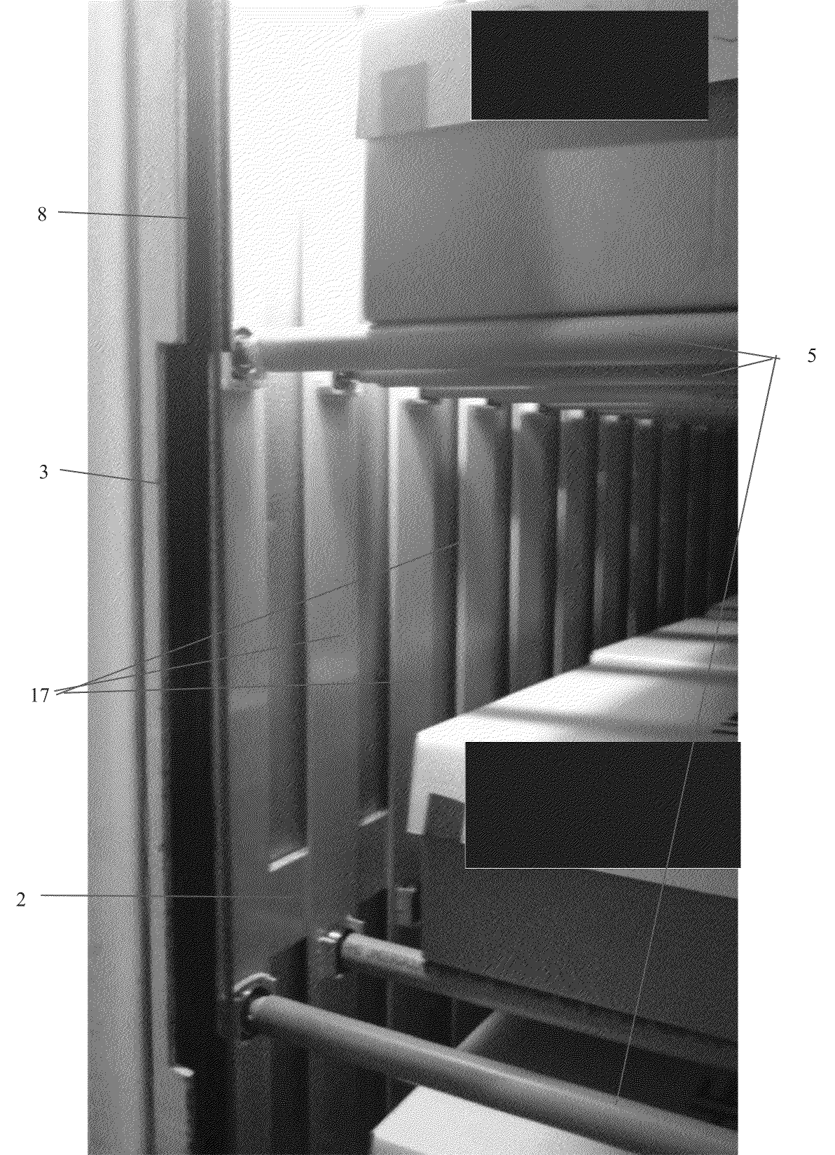

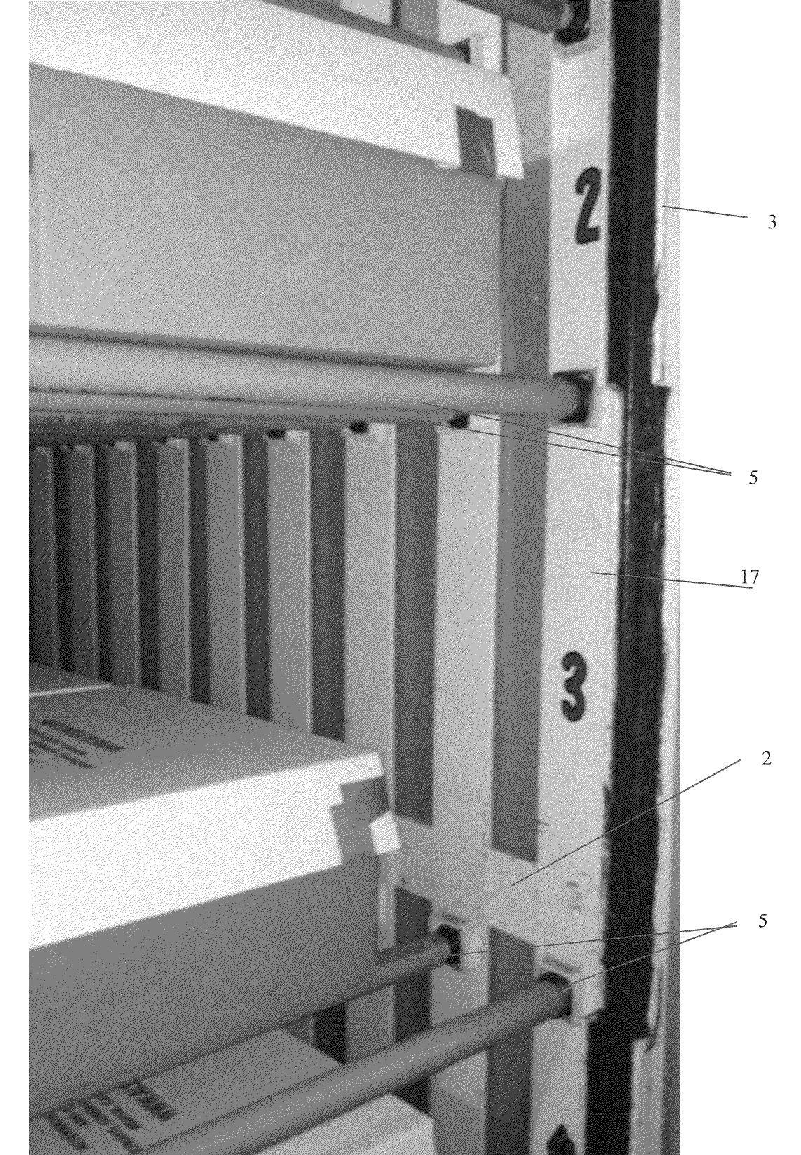

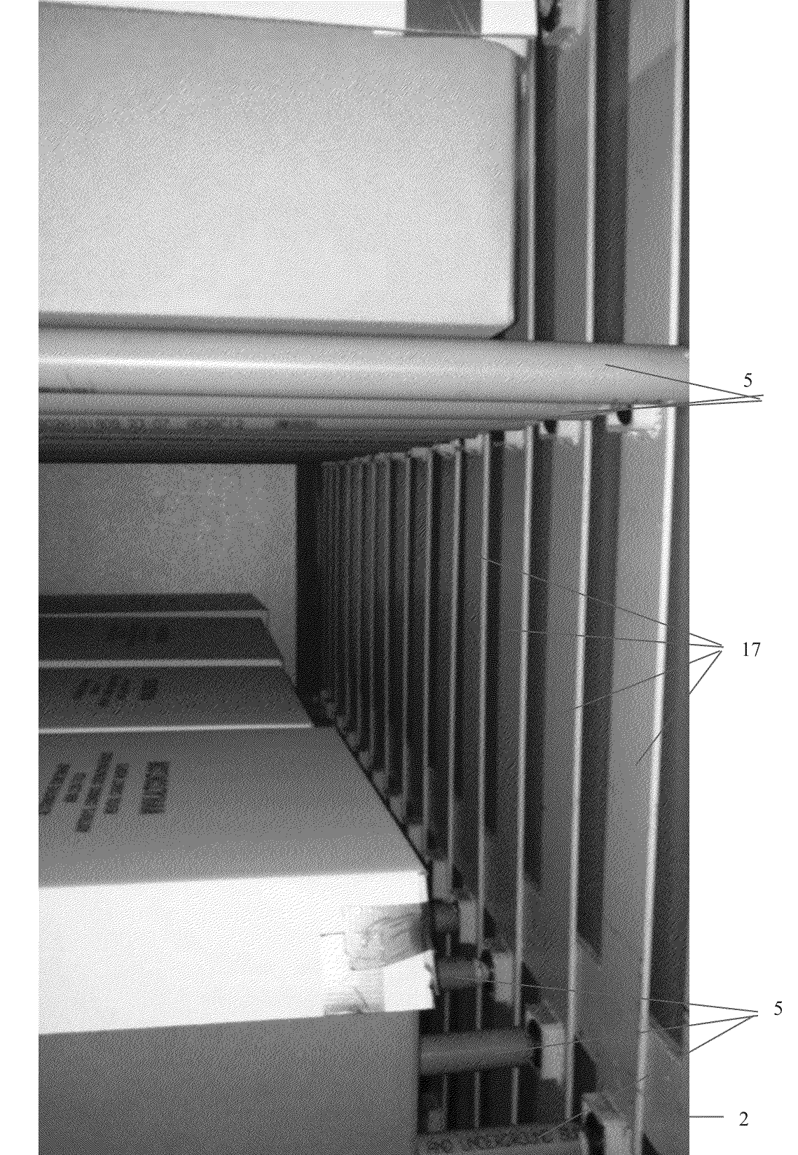

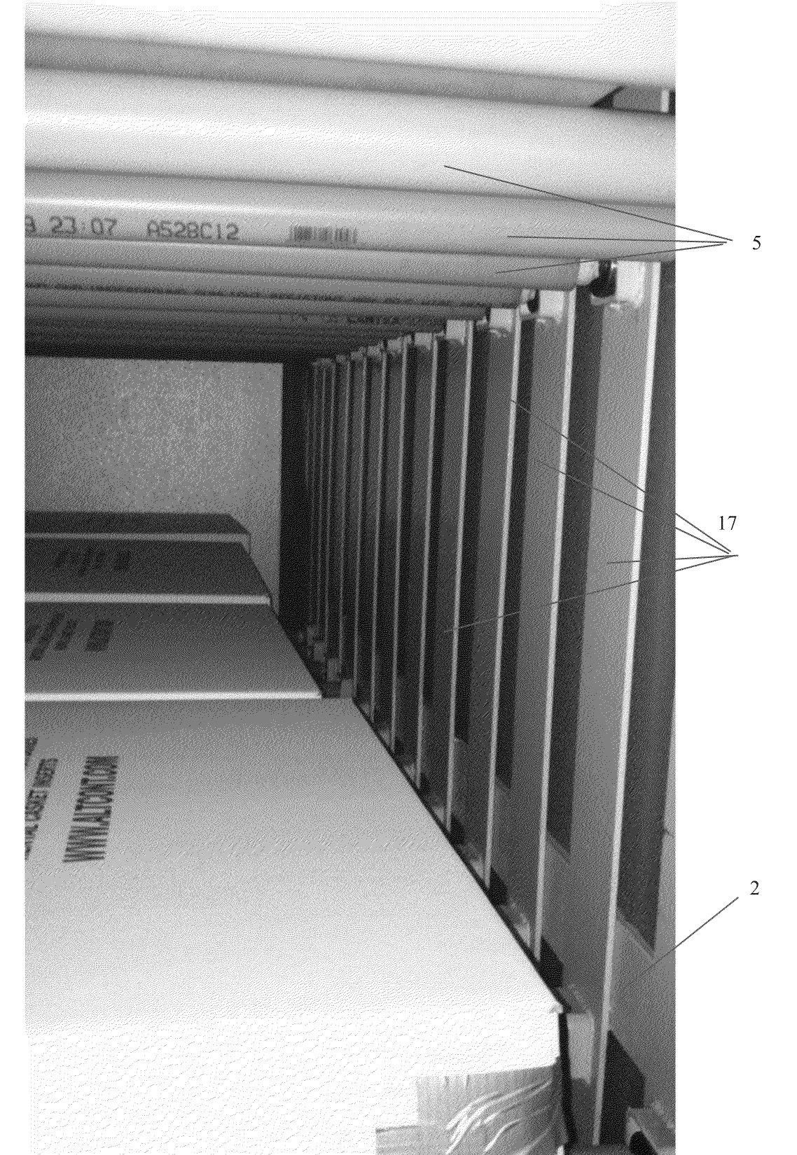

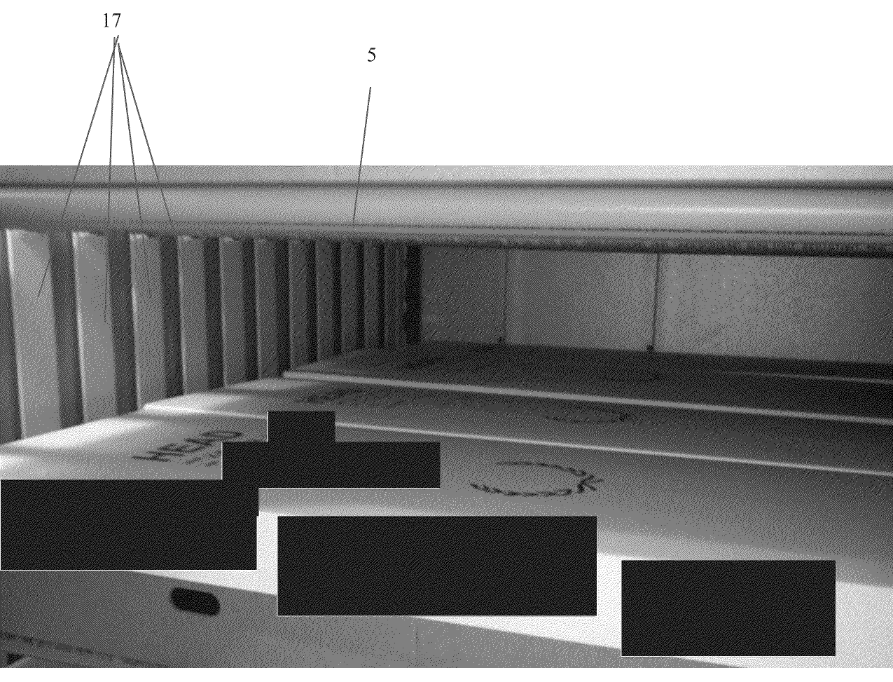

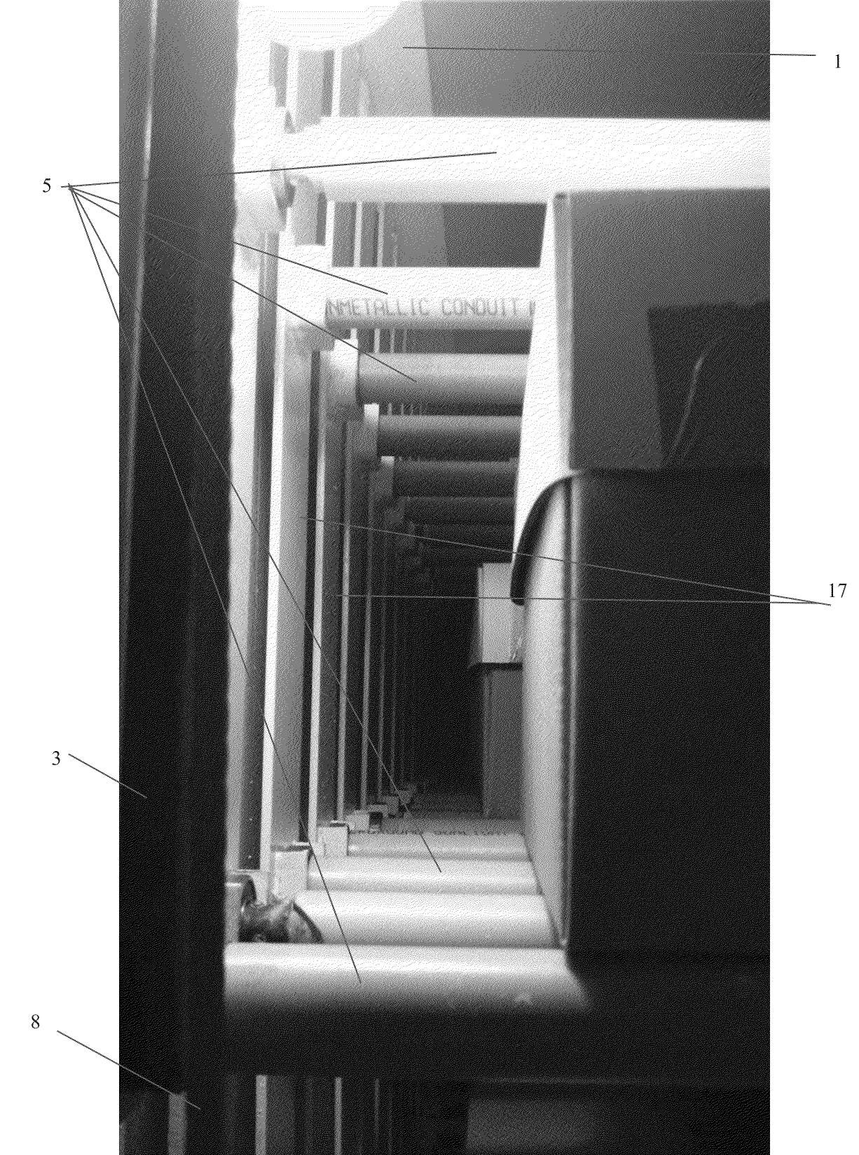

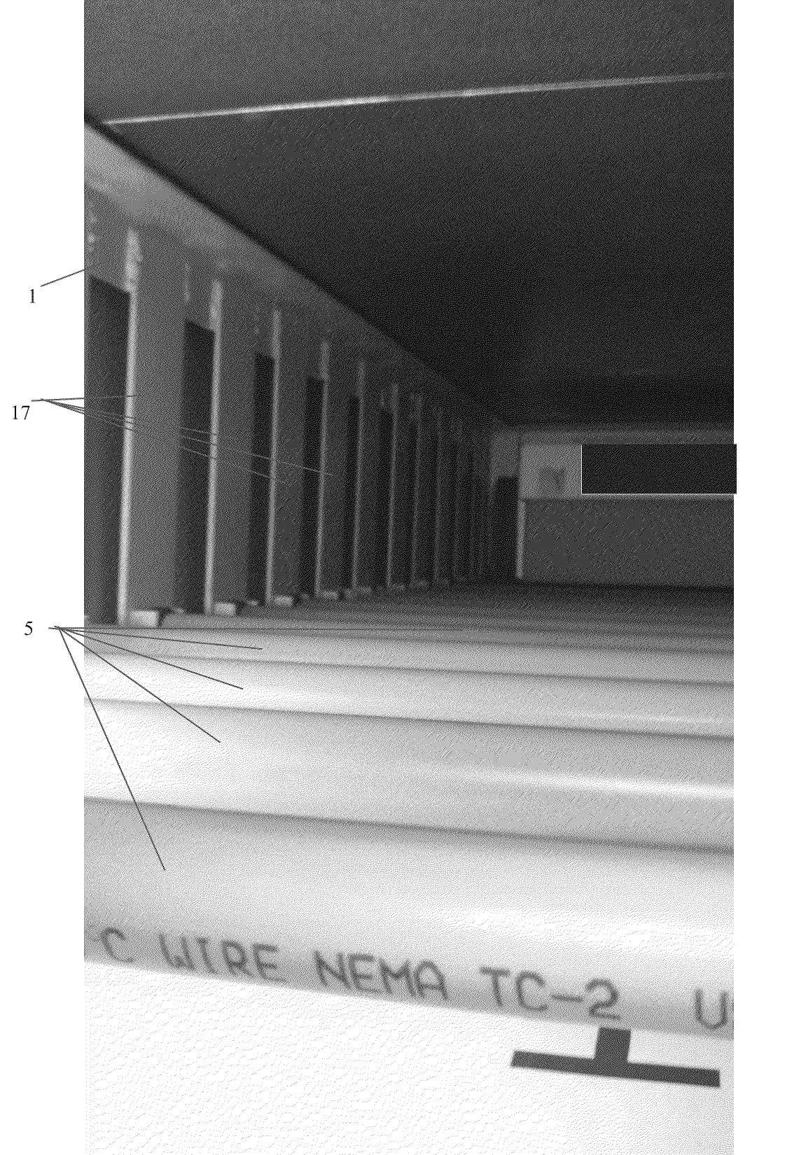

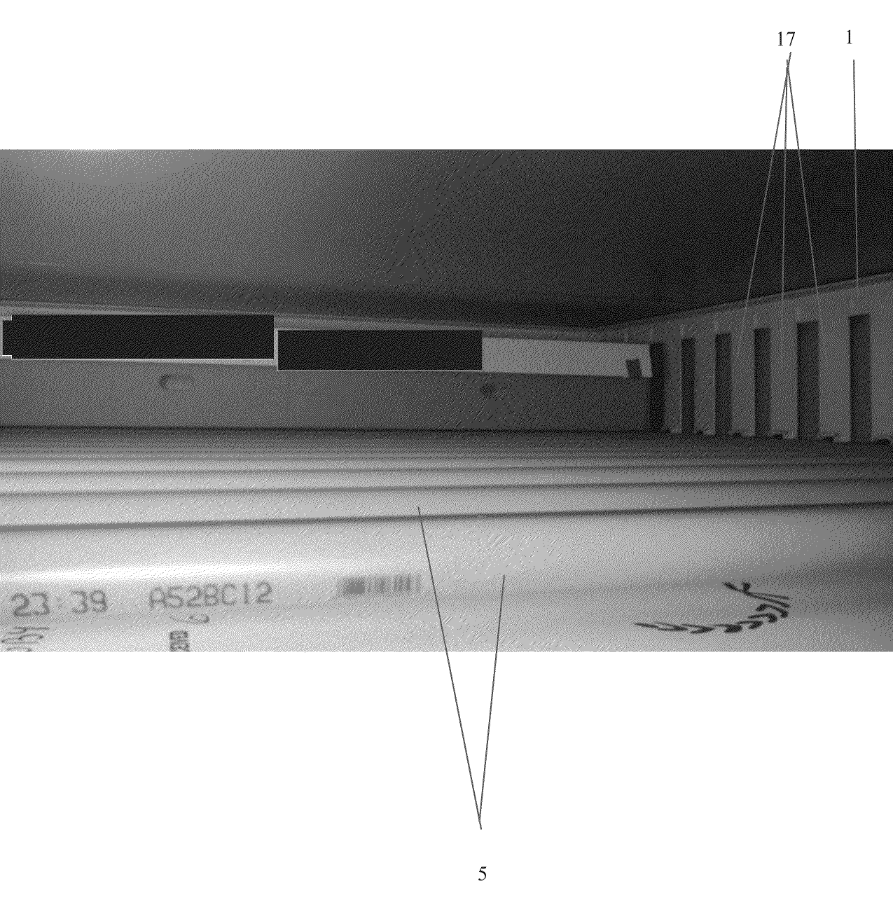

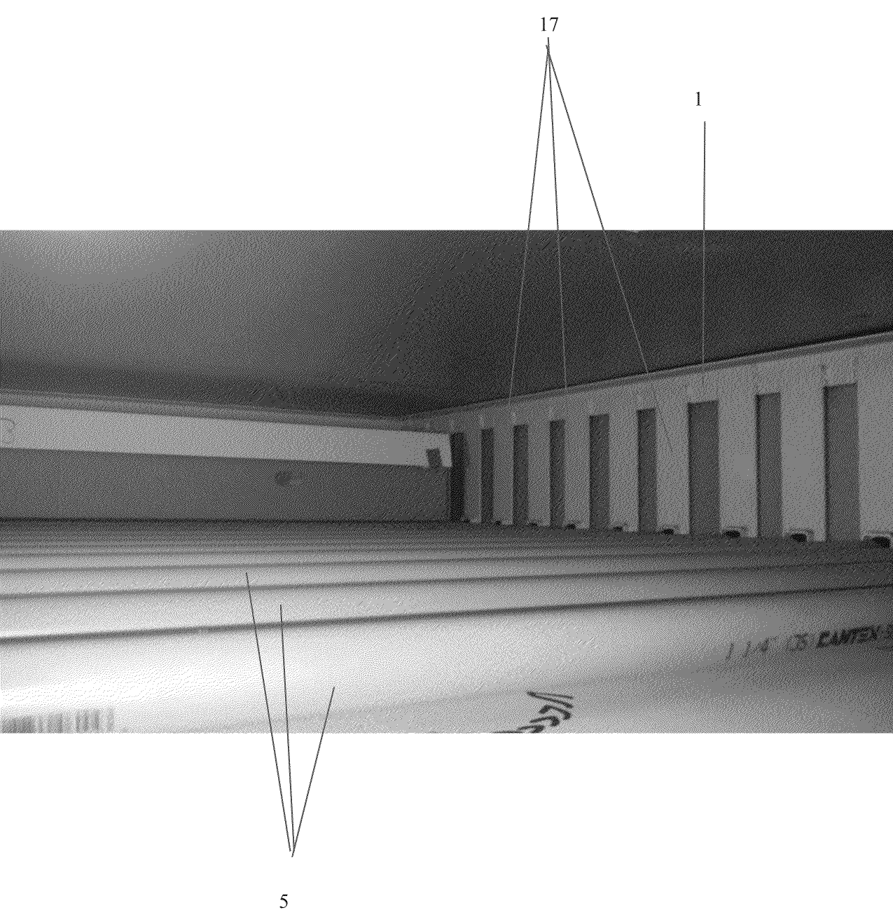

### BACKGROUND

The efficient storage of human remains is a substantial issue within morgues, crematories, and funeral facilities. Whether the storage of human remains is intended to be accommodated in existing spaces or through the establishment of newly constructed or designated spaces, an apparatus which increases the capacity utilization of such spaces provides benefits in terms of higher capacity within existing storage spaces, reduced storage area footprints for new storage spaces, enhancement to existing and inefficient storage spaces, and the reduction of associated storage and operational costs.

Temperature controlled spaces (including but not limited to coolers, and freezers), are a particular storage spaces for human remains which obtain significant benefits from increased utilization of the storage of human remains. The need for efficient storage of human remains within temperature controlled spaces is significant as to both existing areas and areas to be constructed. Within such existing temperature controlled spaces, the capacity for storage of human remains based upon current utilization methods and apparatus within the space is often not easily expanded due to the nature of the fixed construction of the wall, ceiling, and/or floor areas which may also incorporate insulating materials for the space; as well as the spatial limits of the associated structure/facility within which the temperature controlled space is located which may also require expansion, alteration, and/or may limit the ability to expand the capacity of an existing temperature controlled space. In essence, higher capacity utilization for the storage of human remains creates, among other benefits: (1) an ability to design and construct smaller temperature controlled areas and achieve lower construction expenses and operational costs; (2) the ability to implement functional capacity in existing facilities, buildings, and/or areas that would not have otherwise been able to accommodate the demand requirements for the storage of human remains; and (3) in the event of spikes in demand for the storage of human remains a reduced likelihood that the higher demand cannot be accommodated thereby preventing adverse environmental and public health issues that arise when human remains cannot be properly stored.

The storage of human remains is also impacted by variations in height, width, depth, and weight of the remains. Existing storage apparatus such as cots, shelving, and drawers/compartments, do not make efficient accommodation for such variations. In those instances where human remains are wide or have significant height, those human remains may not fit on an existing storage space of a cot, shelf, and/or drawer/compartment having a fixed capacity dimension. Similarly, human remains that are obese or very obese may exceed the capacity of a cot, shelf, and/or drawer/compartment. Instances have become more frequent when human remains exceed 500 or even 700 pounds. In most instances existing technologies do not accommodate the storage of human remains of extraordinary weight. Where the existing physical space for storage is large enough, those human remains of extraordinary weight often require the placement of the remains on a table rather than upon a shelf or cot, thereby reducing the already poor capacity utilization of the storage space.

The inherent capacity inefficiencies of cots, includes but is not limited to the inability to stack cots holding human remains within a storage space; that is in the vertical space a cot is only suitable for the storage of one set of human remains. Furthermore, since the utility of cots arises primarily from the movement of human remains from place to place, the primary benefit or utility of a cot is lost when it is used to simply store human remains in a fixed location within a storage space.

Existing shelf apparatus for the storage of human remains are inefficient as they accommodate the placement of one set of remains upon the shelf. The shelf is a fixed dimension and occupies a fixed space for capacity purposes whether or not the human remains placed therein occupy part or all of that space. Also, each shelf requires an open space adjacent to the shelf for loading and unloading the remains. Those areas which are left open around shelves for the purposes of unloading and loading of the human remains are not able to be used to increase the capacity for the storage of human remains. Further, the process of placing or removing the human remains may require more than one person (additional handlers to place the remains) especially in those in instances where the shelf location is either at a high point or a low point relative to the height of the cot and/or transport surface.

Slide-Out Drawer/Compartments which are used to store human remains provide a single space for the storage of human remains regardless of whether or not those remains occupy only part of the space. As indicated above the dimensional and weight limits of slide-out drawers/compartments may also prevent the storage of any human remains which are wide, tall and/or of a greater weight in relation to the capacity constraints of each of the drawers/compartments. Furthermore, the slide-out drawers/compartments are inefficient for space utilization purposes as their operational characteristics require an additional amount of space which is often nearly equal to the utilized space for storage of each slide-out drawer/compartment for purposes of loading and unloading human remains for each drawer/compartment. In instances such as those, the space surrounding the storage space must be equal to that of the storage space itself to accommodate loading and unloading of the human remains from the storage space. Thus resulting inefficient utilization of space surrounding the storage area.

The utilization of cots, shelves, compartments/drawers as described above, as well as the existing handling practices for the storage of human remains, are inefficient practices for the storage of human remains and are often impractical for single-operator/handler loading and unloading of human remains, in addition to the other limitations associated with variations in height, width, depth, and weight of the human remains, and/or the impracticability for vertical storage placement or removal of the human remains if sought to be stored high or low.

### BRIEF SUMMARY OF THE INVENTION

The apparatus is a Lift and Storage Racking Apparatus for Human Remains to store human remains in an efficient manner. The Lift and Storage Racking Apparatus for Human Remains is comprised of a frame (Fig.Ref.¹ 1); a lift to hold, load and unload human remains (Fig.Ref. 6); at least one level of a plurality of parallel rollers/slides/bearings and/or glides to store the human remains (Fig.Ref. 5); a parallel movement mechanism (Fig.Ref. 13) to maintain a loading and/or unloading plane for the lift; and a means to raise and lower the lift (Fig.Ref. 10). To load human remains into the Lift and Storage Racking Apparatus for Human Remains, the Lift (Fig.Ref. 6) can be raised or lowered by the hoist controls to match the height of the surface from which the human remains are being transferred from. The human remains can then be moved/slid onto the Lift. The Lift can then be raised or lowered to the height of a level of the parallel rollers/slides/bearings and/or glides (generically referred to as “Storage Rollers”—as depicted in Fig.Ref. 5), and then pushed from the Lift onto the Storage Rollers for storage. Additional human remains can be placed on the each level of Storage Rollers until the rollers are full in relation to capacity constraints of the storage space of each level. ¹ “Fig.Ref.”—refers to the figure reference numbers on the drawings which are attached hereto and incorporated by reference. A table/key of references is attached in the Section Brief Description of Drawings with references to the associated Drawing Nos. that the references are located in.

Removal of human remains from any level of the Storage Rollers can be accomplished by raising or lowering the Lift to the level of the Storage Rollers where the human remains have been stored; then by rolling, sliding, and/or gliding the human remains across the Storage Rollers which are adjacent to the Lift, the stored human remains can be rolled/moved/slid onto the Lift. Once the human remains have been placed upon the Lift, the Lift can be raised or lowered to the height of the surface to which the human remains are to be transferred for movement or transport.

The Storage Roller levels accommodate variations of height, width, depth, and weight of human remains, including those of obese or very obese remains. The Storage Rollers allow for as few as a single operator to move extraordinarily large and heavy human remains to and from the Lift. Through operation of the Hoist Controls (Fig. Ref. 23) the Lift can mechanically (whether by motor, screw-jack, pneumatic, and/or hydraulic forces) raise and lower human remains (even those that are extraordinarily large and heavy) to different levels of the Storage Rollers as well as, accommodate their relocation to the height of the surface to which the human remains are being placed for movement/transport.

The multiple levels of Storage Rollers within the storage space allow for varying the heights for storage, as well as allow for an efficient use of vertical storage space within the Lift and Storage Racking Apparatus for Human Remains. The Storage Rollers allow for efficient horizontal storage of human remains in relation to their respective widths. An extension tool and/or retrieval mechanism allows for the retrieval of stored human remains located deeper within the storage area and beyond the ordinary reach of the operator.

The location of the Lift, permits efficient loading, unloading, and relocation of human remains into the various levels of the Storage Rollers without interfering with or encroaching into space outside of the Lift and Storage Racking Apparatus for Human Remains. Human remains can be moved from one level of the Storage Rollers to another through placement upon and use of the Lift. The Lift can also be used to store a set of human remains, and be elevated to a height which allows for the temporary placement of additional human remains on a cot or other structure beneath the Lift, even while the Lift holds human remains. The heavy lifting of human remains for storage is performed by the Lift.

In those instances where the human remains are carried or transported on a surface which is approximately the height of a level of Storage Rollers within the Lift and Storage Racking Apparatus for Human Remains, the human remains may be slid/moved and/or rolled directly upon the Storage Rollers without the use of the Lift. Similarly, human remains may be carried from the Storage Rollers, or moved onto a transportation surface, such as a cot or another lifting mechanism, whose height is made to match the level of the appropriate Storage Rollers without utilizing the Lift within the Lift and Storage Racking Apparatus for Human Remains.

While the implementation of the Lift and Storage Racking Apparatus for Human Remains can be made free-standing, portable (as part of a moveable container), and/or implemented in fixed free standing spaces it can also be implemented within such temperature controlled spaces, including but not limited to fixed and/or portable coolers, and/or freezers; the Lift and Storage Racking Apparatus for Human Remains' components, mechanisms and other elements, may be sized or adjusted to accommodate the relative sizing of those spaces within which the Lift and Storage Racking Apparatus for Human Remains is intended to be installed or utilized, and/or to obtain the desired number of Storage Roller Levels and other capacity requirements. The Storage Rollers (comprised of rollers, glides, slides, and/or bearings or a combination of any of them) can also be covered with a protective covering(s), and spaces can be implemented between the Storage Rollers so that fluids or debris do not pool or collect on each level creating a storage space which is more easily maintained in a sanitary manner given the nature of the function served in the storage of human remains which may various body fluids. Lower level floor pans and/or drains may be incorporate within the space to aid in the cleanup of such contaminants.

### BRIEF DESCRIPTION OF THE DRAWINGS

Drawing No. 1. shows Frame of the Lift and Storage Racking Apparatus for Human Remains—Exterior; Top-Down View.

Drawing No. 2. shows Interior of the Lift and Storage Racking Apparatus for Human Remains, beneath the Frame Top; Top-Down View (including Lift and Top Level of Storage Area).

Drawing No. 3. shows Frame Bottom of the Lift and Storage Racking Apparatus for Human Remains—Interior; Top-Down View.

Drawing No. 4. shows Side perpendicular to Storage Rollers with Entrance of the Lift and Storage Racking Apparatus for Human Remains—Exterior; Side-View.

Drawing No. 5. shows Side perpendicular to Storage Rollers without Entrance of the Lift and Storage Racking Apparatus for Human Remains—Exterior; Side-View.

Drawing No. 6. shows Side parallel to but not adjacent to the Storage Rollers of the Lift and Storage Racking Apparatus for Human Remains—Exterior; Side-View.

Drawing No. 7. shows Side parallel to and adjacent to the Storage Rollers of the Lift and Storage Racking Apparatus for Human Remains—Interior; Side-View (with Lift and Storage Area—Storage Roller levels).

Drawing No. 8. shows Side parallel to and adjacent to the Storage Rollers of the Lift and Storage Racking Apparatus for Human Remains—Interior; Side-View (Storage Area—Storage Roller levels).

Drawing No. 9. shows Side parallel to and adjacent to the Storage Rollers of the Lift and Storage Racking Apparatus for Human Remains—Interior; Side-View (Frame).

### TABLE OF FIGURE REFERENCES WITHIN DRAWINGS

The following figure references are used consistently as references to elements, components, and/or mechanisms as generally identified herein for reference:

FIG. Ref. - Gen. Descr. (On Drawing No.)

| | | |
|---|---|---|
| 1 | Frame Corner(s) | 1-6, 9 |
| 2 | Frame Brace(s) | 1, 3-5, 7-9 |
| 3 | Vertical Guide Channel | 2, 4, 5, 7 |
| 4 | Vertical PMM Channel | 2, 6 |
| 5 | Storage Roller(s) | 2, 7, 8 |
| 6 | Lift | 2, 4, 7 |
| 7 | Lift Roller(s) | 2 |
| 8 | Lifting Cable | 2, 4, 6, 7 |
| 9 | Hoist Cable | 2, 4, 6 |
| 10 | Hoist | 2, 4, 6 |
| 11 | Lifting Pulley | 2, 7 |
| 12 | Upper Guide Pulley | 2, 6 |
| 13 | Parallel Movement | 2, 6 |
| | Mechanism | |
| 14 | Hoist Pulley | 2, 4, 6 |
| 15 | Intermediate Cable | 2, 4, 6 |
| 16 | Lower Guide Pulley | 2, 4, 6 |
| 17 | Storage Roller Support(s) | 4, 5, 8 |
| 18 | Block Pulley | 6 |
| 19 | Intermediate Cable Connection | 6 |
| 20 | Cable Connecting Component | 6 |
| 21 | Lower Guide Plate | 6 |
| 22 | Scissor Mechanism | 6 |
| 23 | Hoist Control | 6 |

Photographs:

Forty-six (46) photographs are attached hereto and incorporated herein by reference, which depict portions of the Lift and Storage Racking Apparatus for Human Remains, together with its various components, devices, mechanisms and their connections, which is fully-functional and operational as a Lift and Storage Racking Apparatus for Human Remains; the depicted apparatus includes the incorporation of rollers for the Storage Rollers while glides, slides, and/or bearings might be incorporated for movement of remains across a particular level. Likewise, the apparatus as shown also incorporates a parallel movement mechanism that is driven by a motor-hoist and cabling, whereas other mechanisms such as hydraulic, screw-jack, pneumatic, and/or other movement mechanisms might be employed to achieve the parallel movement of the lift mechanism adjacent to the varying levels of Storage Rollers. (where reference numbers appear within the photographs, they correspond to the Figure References set forth in the Drawing Figure Reference table above).

### DETAILED DESCRIPTION AND BEST MODE OF IMPLEMENTATION

The Lift and Storage Racking Apparatus for Human Remains is comprised of a Frame (Fig.Ref. 1); a Lift (Fig.Ref. 6) to hold, load and unloading human remains; at least one level of a plurality of parallel rollers (“Storage Rollers”—Fig.Ref. 5) to store the human remains; a Parallel Movement Mechanism (Fig.Ref. 13) to maintain the Lift parallel to the Storage Rollers as the Lift is moved; and a means to raise and lower the lift.

The Lift and Storage Racking Apparatus for Human Remains's Frame (Fig.Ref. 1) is a structure which provides physical support for each parallel level of Storage Rollers within the Lift and Storage Racking Apparatus for Human Remains, as well as a physical support and connection for the means to raise and lower the Lift; including the physical support and connection for the Parallel Movement Mechanism. The Frame is comprised of high strength materials, including but not limited to steel, metal, or other strong material pieces which can be welded or securely fastened together and/or to other materials and/or objects. The Frame's corners (“Frame Corners”) (Fig. Ref. 1) are comprised of structural components such as 90 degree angle, channel, tubular materials, or such structurally sound equivalents; an opening is left along the corner of the Frame which would otherwise obstruct the entryway into the Lift and Storage Racking Apparatus for Human Remains. The top of the Frame includes Frame Corners (Fig.Ref. 1) and Frame Braces/Bracing (Fig.Ref 2) connected between the Frame Corners for stability purposes. The sides of the Frame are comprised of Frame Braces attached between the top and bottom Frame Corners; and within the storage area of the Lift and Storage Racking Apparatus for Human Remains the top and bottom Frame Corners of the Frame which are perpendicular to the Storage Rollers (Fig.Ref. 5) are connected to each end of a plurality of parallel Storage Roller Supports (Fig.Ref. 17) which are aligned with Storage Roller Supports on the opposite side of the storage area. Frame Braces also run perpendicular to and across the inside and/or outside portion of the Storage Roller Supports. The bottom of the Frame is comprised with Frame Corners and Frame Braces; wherein the bottom Frame Braces are parallel beneath the Storage Rollers, and their ends are attached between the parallel bottom Frame Corners. All Frame Bracing referenced in this paragraph and/or depicted in the drawings is optional, unless it is required for the attachment of a necessary component, or is desirable for stability and/or capacity purposes. Accordingly, the installation, and/or utilization, or lack thereof of Frame Bracing may vary due to configuration, location, and/or other characteristics, depending on the sizing and capacity of the Lift and Storage Racking Apparatus for Human Remains which is being implemented on a case-by-case basis, moreover, existing walls, ceilings, and floor of the storage space (whether in the form of a container, cooler, room, building, structure, and/or combination of any of them that may serve as a substitute if otherwise stable and supportive of the function which would otherwise be served by the frame corners and/or its bracing); the drawings attached hereto show bracing as an illustrative example and/or for demonstrative purposes.

The storage area within the Lift and Storage Racking Apparatus for Human Remains is comprised of at least one level of a plurality of horizontal parallel rollers (“Storage Rollers”—Fig.Ref. 5) upon which human remains are to be stored. A Storage Roller comprises a round pipe, or round rod, or rod protruding from each end of a round pipe, the ends of which are placed within bearings at each end of the round pipe or rod, the bearings of which are supported upon and perpendicular to the sides of the Storage Roller Supports (Fig.Ref. 17); wherein each Storage Roller is placed parallel to the adjacent Storage Roller(s); for the storage of human remains. In this illustration the Storage Rollers are comprised of “rollers,” although rollers, slides, glides, and/or bearings (or any combination of any of them) may also be implemented for purposes of allowing the parallel movement of the remains across the level of the plurality of such generically named “Storage Rollers.” Thus, the configuration of substituted slides, glides and/or bearings, maybe altered from that of the rollers as shown in order to provide a parallel surface for the storage and movement of human remains within the storage area of the apparatus.

The Lift (Fig.Ref. 6) which is comprised of a platform/surface (wherein said platform/surface is composed of structural materials capable of carrying human remains of varied weight, comprising tubular, ‘I’ channel, ‘C’ channel, ‘H’ channel, and/or any other structurally strong materials such as metal, carbon fiber, and/or any other strong materials to minimize deflection when under load upon which human remains are held, or is utilized for loading and unloading human remains, and raising or lowering the human remains so that they are adjacent to level(s) of Storage Rollers and approximately parallel to the Storage Rollers, to accommodate the varied heights of at least as low as the lowest level of Storage Rollers and to as high as the highest level of Storage Rollers, or such greater heights to allow for the placement of the Lift so that it does not obstruct or interfere with movement within the apparatus. The platform of the Lift maybe flat, and/or also contain a plurality of rollers (“Lift Rollers”—Fig. Ref. 7), and/or a functionally equivalent materials or devices to minimize the effect of friction including but not limited to anti-friction materials, surface, bearings, glides, rollers, and/or slides to aid in the loading and unloading of human remains from the Lift's surface. The Lift as shown is placed within and guided by channels (“Vertical Guide Channels”—Fig.Ref. 3) (such channels may also be in form of any other guide component such as a ‘T,’ ‘I,’ or other track which operates to guide the Lift) affixed vertically to the top and bottom Frame Corners adjacent to the Lift location, so that the Lift surface remains parallel and adjacent to the Storage Rollers. Other configurations could be implemented with respect to the Lift so that its vertical movement allows for an alignment adjacent to the Storage Rollers for the purposes of loading and/or unloading remains.

The Scissor Mechanism (Fig.Ref. 22) is comprised of at least a pair of duplicate rectangular flat steel or equivalent strong materials, having at least a hole in the point at the middle of the width and length of said rectangular pieces, with equidistant holes placed near each end of said rectangular pieces, at the center of their width, with each pair connected by a pin or bolt or equivalent placed with the hole at the center of length; and/or depending upon the height and/or width of retraction and/or extension needed to allow for the corresponding required movement of the Cable Connecting Component (Fig.Ref. 20) such that the Lift (Fig.Ref. 6) has the required range of movement to reach the lowest level of Storage Rollers (Fig.Ref. 5), as well as the highest level of Storage Rollers, additional pairs of scissor components of equal size and construction could be conjoined together with pins or bolts or the equivalent, so as obtain the necessary extension and retraction and to maintain the scissor action of the pairs as conjoined.

The Parallel Movement Mechanism (Fig.Ref. 13) is comprised of a Cable Connecting Component (Fig.Ref. 20), which is placed horizontally with each end situated within a Vertical PMM Channel (Fig.Ref. 4) that is vertically parallel to the other Vertical PMM Channel at the other end of the Cable Connecting Component; wherein each Vertical PMM Channel is securely attached at its top end to the upper Frame Corner and similarly connected at is bottom end to the lower Frame Corner; wherein the Cable Connecting Component has at least two parallel slots which serve as connection points to the top part of the Scissor Mechanism (Fig.Ref. 22) which is attached with bolts, pins or the equivalent, that are placed through bushings (optional), and located and inserted within the parallel slots of the Cable Connecting Component (Fig.Ref. 20); the bottom of the Scissor Mechanism is attached in a similar fashion to the Lower Guide Plate (Fig.Ref. 21), with bolts, pins or the equivalent, which are placed through bushings within the parallel slots of the Lower Guide Plate; whereas the left and right edges of the Lower Guide Plate are securely connected by welding, bolting or the equivalent, to their respective Vertical PMM Channel (Fig.Ref. 4). While the Parallel Movement Mechanism (Fig.Ref. 13) is described and depicted in a particular orientation between Frame Corners—that configuration is intended to illustrate the relative operation and function of the mechanism in relation to the other connected components; the Parallel Movement Mechanism could be relocated to other available areas of the Frame, such as another available area between Frame Corners, or reoriented (i.e. it could be operated upside down to its current configuration or turned horizontal provided that requisite associated connected parts were also reoriented to a respective alternative position so that the function would be maintained). (Also, other functionally equivalent devices such as properly installed motor and/or manually driven screw-jack(s), pneumatic and/or hydraulic cylinder(s) with ram(s), could be utilized as an equivalent or substitute mechanism to allow for the extension and retraction of the Cable Connecting Component so that the movement of the Lift allows for the Lift's platform/surface area to remain parallel to the Storage Rollers, wherein the controls for such substitute devices when properly affixed to the Lift and/or Intermediate Cable Connection might also replace the: all and/or part of the Intermediate Cable Connection (Fig.Ref. 19), the Lower Guide Plate (Fig.Ref. 21), the Scissor Mechanism (Fig.Ref. 22), the Lower Guide Pulley(s) (Fig.Ref. 16), the Hoist Pulley (Fig.Ref. 14), the Hoist Cable (Fig.Ref. 9), the Hoist (Fig.Ref. 10), and/or the Hoist Control (Fig.Ref. 23).

The means to raise and lower the Lift is comprised of: Lifting Pulleys (Fig.Ref. 11); Upper Guide Pulleys (Fig.Ref. 12); Block Pulleys (Fig.Ref. 18); a Parallel Movement Mechanism or its equivalent (Fig.Ref. 13); Lower Guide Pulleys (Fig.Ref. 16); a Hoist Pulley (Fig.Ref. 14); a Hoist (Fig.Ref. 10) or equivalent extension or retraction device including but not limited to a hydraulic and/or air cylinder and ram, a screw-jack mechansim; and cabling (such as steel rope, rope, chain or the equivalent) including a Lifting Cable (Fig.Ref. 8), Intermediate Cable (Fig.Ref. 15), and a Hoist Cable (Fig. Ref. 9). A Lifting Cable (Fig.Ref. 9) (such as steel rope, rope, chain or the equivalent) is affixed to the top of at least: (1) the corner of the Lift (Fig.Ref. 6) which is closest to the Storage Rollers (Fig.Ref. 5) which is not adjacent to more than one Vertical Guide Channel (Fig.Ref. 3); and (2) at least two other corners of the Lift within Vertical Guide Channels that are adjacent to each other which are not a corner of the Lift which is to be located adjacent to the Storage Rollers. Each Lifting Cable (Fig.Ref. 8) attached to the top of the Lift (Fig.Ref. 6) passes through its respective Lifting Pulley (Fig.Ref. 11) (which is attached to the Frame Corner (Fig.Ref. 1), and/or Frame Brace (Fig.Ref. 2) above the point of connection of the Lifting Cable to the Lift platform, with the pulley wheel oriented vertically) then through its respective Upper Guide Pulley (Fig. Ref. 12) that is attached to the Frame Corner and/or Frame Brace (with the pulley wheel vertically oriented) at a point above the Parallel Movement Mechanism (Fig.Ref. 13), so that the Lifting Cable aligns with the respective Block Pulley (Fig.Ref. 18) above the Parallel Movement Mechanism, the Lifting Cable passes through the Block Pulley which is beneath its Upper Guide Pulley (Fig.Ref. 12) and attaches to a hook or equivalent cable connector which is attached to a ring or hole on the Frame Corner and/or Frame Brace adjacent to that Lifting Cable's Upper Guide Pulley. The Block Pulleys (Fig.Ref. 18) are connected to the Parallel Movement Mechanism (Fig.Ref. 13) by a hook or equivalent connector which connects to a threaded bolt or eye-bolt or the equivalent which is attached to the top of the Cable Connecting Component (Fig.Ref. 20) of the Parallel Movement Mechanism. A u-bolt, ring, threaded eye-bolt or an equivalent (“Intermediate Cable Connection”—(Fig.Ref. 19)) is securely attached to the horizontal center of the bottom of the Cable Connecting Component (Fig.Ref. 20). An Intermediate Cable (Fig.Ref. 15) (such as steel rope, rope, chain or the equivalent) is attached by hook or equivalent cable connecting device to the Intermediate Cable Connection. The Intermediate Cable passes through the Lower Guide Pulley (Fig.Ref. 16) that is attached to the top of the bottom Frame Corner (Fig.Ref. 1) located beneath the horizontal center of the Cable Connecting Component. The Intermediate Cable passes from said Lower Guide Pulley horizontally through a hole in the Vertical PMM Channel (Fig. Ref. 4) and through the Lower Guide Pulley that is attached to the top of the bottom Frame Corner located near to the other side of the Vertical PMM Channel which is between the two Lower Guide Pulleys. The Lower Guide Pulleys (Fig.Ref. 16) are attached to the Frame Corner so that their respective pulley wheel is vertical and parallel to the Frame component that they are attached to. The end of the Intermediate Cable (Fig.Ref. 15) is attached to a hook or other equivalent connector of the Hoist Pulley (Fig.Ref. 14). The Hoist (Fig.Ref. 10) or equivalent extension or retraction device is securely attached to the upper Frame Corner so that it is situated catty corner to the Lower Guide Pulley (Fig.Ref. 16) that is nearest to the Hoist Pulley. The Hoist Cable (Fig.Ref. 9) passes from the Hoist and through the Hoist Pulley and is attached by hook or other connecting device to the Hoist, a connecting ring attached to the Frame Corner, or a hole in the frame located near the hoist. If an equivalent device, including but limited to a motor and/or manually driven hydraulic and/or pnuematic cylinder with a ram, and/or screw-jack is used in place of a Hoist then that equivalent may be attached with or without either a Hoist Cable, and/or Hoist Pulley, such that the Intermediate Cable (Fig.Ref. 15) is connected to the extension and retraction component of such equivalent device, so as to be able to move the Intermediate Cable to raise or lower the Lift.

As result of the connections of components, devices, mechanisms, pulleys and cables described above, through the operation of the Hoist Control (Fig.Ref. 23) (or the applicable controls for the Hoist equivalent), as the Hoist operation causes retraction (as shown) the Lift (Fig.Ref. 6) will rise and the platform/surface of the Lift will remain parallel to the Storage Rollers (Fig.Ref. 5), and when the Hoist operation allows extension the Lift will lower while the platform/surface of the Lift will remain parallel to the Storage Rollers.

To load human remains into the Lift and Storage Racking Apparatus for Human Remains, the Lift (Fig.Ref. 6) can be raised or lowered by use of the Hoist Control (Fig.Ref. 23), so that the Lift is at the approximate height of the surface from which the human remains are being relocated from. The human remains can then be slid onto the Lift. The Lift can then be raised or lowered to the height of a level of the Storage Rollers (Fig.Ref. 5), and then the human remains can be pushed from the Lift onto the Storage Rollers for storage. Additional human remains can be placed on the each level of the Storage Rollers until the Storage Rollers are full.

Removal of remains from any level of the Storage Rollers (Fig.Ref. 5) can be accomplished by rolling the stored human remains to the Storage Rollers adjacent to the Lift (Fig.Ref. 6), then by raising or lowering the Lift to the level of Storage Rollers where the human remains are to be removed the human remains can be slid from the Storage Rollers onto the Lift. Once the human remains have been placed upon the Lift, the Lift can be raised or lowered to the height of the surface to which the human remains are being placed for movement/transport.

The use of the Storage Rollers can accommodate the variations of height, width, depth, and weight of human remains, including but not limited to those of extraordinary weight of severely obese human remains.

The implementation of the Lift and Storage Rollers allows for as few as a single operator to move extraordinarily large and/or heavy human remains to and from the Lift; as the operation of the Hoist will mechanically accommodate the raising and lowering of even extraordinarily large and heavy human remains to different levels within the storage area as well as, accommodate their relocation to the height of the surface to which the human remains are being placed for movement/transport.

The levels of Storage Rollers within the storage area provide for varying level heights of storage, as well as an efficient use of vertical storage space within the Lift and Storage Racking Apparatus for Human Remains. The Storage Rollers allow for efficient horizontal storage of human remains in relation to their respective widths. The use of an extension/reach tool allows for the retrieval of human remains from the back of the Storage Rollers.

The location of the Lift, permits efficient loading, unloading, and relocation of human remains within the Lift and Storage Racking Apparatus for Human Remains without interfering with or encroaching into space outside of the Lift and Lift and Storage Racking Apparatus for Human Remains.

Human remains can be moved from one level of the Storage Rollers to another through placement upon and use of the Lift.

The Lift can also be used to store a set of human remains, and be elevated to a height which allows for the temporary placement of additional human remains on a cot or other structure beneath the Lift, even while the Lift holds human remains.

The heavy lifting of human remains for storage is performed by the Lift and/or its related Hoist and/or the Hoists described equivalent substitute device(s) and the components if any connected thereto with the Lift.

In those instances where the human remains are carried or transported on a surface which is approximately the height of a level of Storage Rollers, the human remains may be placed directly upon the Storage Rollers without the use of the Lift (as the Lift may be raised to the near the ceiling so that area adjacent to the Storage Rollers is not obstructed by the Lift. Similarly, human remains may be carried from the Storage Rollers and manually place onto a transportation surface, such as a cot or another transportation device without utilizing the Lift within Lift and Storage Racking Apparatus for Human Remains.

While the implementation of Lift and Storage Racking Apparatus for Human Remains can be made in other spaces, container(s) (whether fixed and/or portable), room(s), and/or structure(s), it can be implemented within temperature controlled spaces, container(s) (whether fixed and/or portable), room(s), and/or structure(s), including but not limited to coolers, and/or freezers; the Lift and Storage Racking Apparatus for Human Remains's components, mechanisms and other elements, may be sized or adjusted to accommodate the relative sizing of those spaces within which Lift and Storage Racking Apparatus for Human Remains will be utilized, and/or to obtain the desired number of Storage Roller levels and other capacity requirements. Such spaces described herein may be fixed to the ground, and/or within building(s), and/or may also be free-standing and/or portable. Moreover, the storage area may be modularly constructed and/or contained for separation and transport, in a manner which is disconnected and/or separate from the associated Lift mechanism which may be modular for independent transport of the apparatus's storage space.

The Storage Rollers (whether rollers, glides, slide, and/or bearings) can be covered with a protective covering(s), and spaces may be maintained between the Storage Rollers so that fluids or debris will not pool or collect thereby creating a storage space which can be maintained in a more sanitary manner.

The Frame Corner(s) (Fig.Ref. 1), the Frame Brace(s) (Fig.Ref. 2), Vertical Guide Channel(s) (Fig.Ref. 3), Vertical PMM Channel(s) (Fig.Ref. 4), and/or Storage Roller Supports (Fig.Ref. 17), as referenced in this application, may be substituted with equivalent component(s) and/or function(s) obtained through the use of the floor(s), side(s), wall(s), and/or ceiling(s) of the building, room, structure, containers, and/or device (such as a temperature controlled device including but not limited to a cooler and/or freezer) or any of their characteristic which incorporates other components of the Lift and Storage Racking Apparatus for Human Remains. By way of example, which is not intended to be limiting of all such types of substitutions or equivalents contemplated herein: (1) the Storage Rollers (Fig.Ref. 5) may be supported by, incorporated in, and/or attached to the side(s) or wall(s) of the building, room, structure, and/or device (such as a temperature controlled device including but not limited to a cooler and/or freezer), which contains, includes, or incorporates other components of the Lift and Storage Racking Apparatus for Human Remains in such a manner that their intended function may be performed as to such other components of the Lift and Storage Racking Apparatus for Human Remains; (2) the corners of the Lift (Fig.Ref. 6) may be located within vertical channels within the side(s) or wall(s) of the building, room, structure, container, and/or device (such as a temperature controlled device including but not limited to a cooler and/or freezer), which incorporates other components of the Lift and Storage Racking Apparatus for Human Remains in such a manner that their intended function may be performed as to such other components of the Lift and Storage Racking Apparatus for Human Remains; and/or (3) the Lift Pulley(s) (Fig.Ref. 11), Upper Guide Pulley(s) (Fig.Ref. 12), and/or Lower Guide Pulley(s) (Fig.Ref. 16) may be supported by, incorporated in, and/or attached to the floor(s), side(s), wall(s), and/or ceiling(s) of the building, room, structure, container, and/or device (such as a temperature controlled device including but not limited to a cooler and/or freezer), which incorporates other components of the Lift and Storage Racking Apparatus for Human Remains, in such a manner that their intended function may be performed as to such other components of the Lift and Storage Racking Apparatus for Human Remains.

The following claims, are not intended to be limiting with respect any additional independent or dependant claims which may be more fully asserted as permitted by law, which are derived from: the apparatus, components, devices, disclosures, diagrams, utilities, and/or methods set forth within this application; and/or incorporated by reference or attachment to this application.

1. An apparatus for lifting and storing human remains, which comprises:
(a) a frame;
(b) a lift to hold and move the human remains vertically;
(c) at least one level of a plurality of parallel rollers, slides, glides, and/or bearings, connected to the frame and located next to the lift upon which to store the human remains;
(d) a parallel movement mechanism; and
(e) a means for raising or lowering the lift.

2. An apparatus for storing human remains, which comprises:
(a) a frame; and,
(b) at least one level of a plurality of parallel rollers, slides, glides, and/or bearings, connected to the frame and located next to the lift upon which to store the human remains.

3. An apparatus for lifting human remains, which comprises:
(a) a frame;
(b) a parallel movement mechanism; and
(c) a means for raising or lowering the lift.

3. An apparatus for storing human remains which is temperature controlled, which comprises:
(a) a temperature controlled container, structure, room, cooler, or freezer containing;
(b) a frame;
(c) a lift to hold and move the human remains vertically;
(d) at least one level of a plurality of parallel rollers, slides, glides, and/or bearings, connected to the frame and located next to the lift upon which to store the human remains;
(e) a parallel movement mechanism; and
(f) a means for raising or lowering the lift.

4. An apparatus for storing human remains in a temperature controlled environment, which comprises:
(a) a temperature controlled container, structure, room, cooler, or freezer containing;
(b) a frame; and,
(c) at least one level of a plurality of parallel rollers, slides, glides, and/or bearings, connected to the frame and located next to the lift upon which to store the human remains.

5. An apparatus for storing human remains in a temperature controlled environment, which comprises:
(a) a temperature controlled container, structure, room, cooler, or freezer containing; and,
(b) at least one level of a plurality of parallel rollers, slides, glides, and/or bearings, connected to the frame and located next to the lift upon which to store the human remains.

7. A method for storing human remains, which comprises:
(a) a temperature controlled container, structure, room, cooler, or freezer containing; and,
(b) at least one level of a plurality of parallel rollers, slides, glides, and/or bearings, connected to the frame and located next to the lift upon which to store the human remains.

6. A method for storing human remains, which comprises:
(a) a temperature controlled container, structure, room, cooler, or freezer containing;
(b) a frame;
(c) a lift to hold and move the human remains vertically;
(d) at least one level of a plurality of parallel rollers, slides, glides, and/or bearings, connected to the frame and located next to the lift upon which to store the human remains;
(e) a parallel movement mechanism; and
(f) a means for raising or lowering the lift.

7. A method for storing human remains in a temperature controlled environment, which comprises:
(a) a temperature controlled container, structure, room, cooler, or freezer containing; and,
(b) at least one level of a plurality of parallel rollers, slides, glides, and/or bearings, connected to the frame and located next to the lift upon which to store the human remains.

8. A method for storing human remains which is temperature controlled, which comprises:
(a) a temperature controlled container, structure, room, cooler, or freezer containing;
(b) a frame;
(c) a lift to hold and move the human remains vertically;
(d) at least one level of a plurality of parallel rollers, slides, glides, and/or bearings, connected to the frame and located next to the lift upon which to store the human remains;
(e) a parallel movement mechanism; and
(f) a means for raising or lowering the lift.
